(19) United States
(12) Patent Application Publication
(10) Pub. No.: US 2025/0066889 A1
(43) Pub. Date: Feb. 27, 2025

(54) SOFT MAGNETIC ALLOY AND MAGNETIC COMPONENT

(71) Applicant: TDK CORPORATION, Tokyo (JP)

(72) Inventors: Kensuke ARA, Tokyo (JP); Hajime AMANO, Tokyo (JP); Kazuhiro YOSHIDOME, Tokyo (JP); Takuya TSUKAHARA, Tokyo (JP)

(73) Assignee: TDK CORPORATION, Tokyo (JP)

(21) Appl. No.: 18/724,660

(22) PCT Filed: Aug. 31, 2022
(86) PCT No.: PCT/JP2022/032860

§ 371 Date: Jun. 27, 2024

(30) Foreign Application Priority Data
Dec. 28, 2021 (JP) 2021-215022

(51) Int. Cl. C22C 38/10; C22C 38/00; C22C 38/02; C22C 38/04; C22C 38/12; C22C 38/14; C22C 38/30; C22C 38/32

(52) U.S. Cl. CPC C22C 38/10; C22C 38/002; C22C 38/02; C22C 38/04; C22C 38/105; C22C 38/12; C22C 38/14; C22C 38/30; C22C 38/32; C22C 2202/02

(57) ABSTRACT

This soft magnetic alloy contains Fe, Co, and at least one selected from among M and X. M is at least one selected from among Ti, V, Cr, Zr, Nb, Mo, Hf, Ta, and W. X is at least one selected from among Si, B, C and P. A volume ratio of a portion in which both the content of Fe and the total content of M and X fall within specific ranges have a specific relationship with a volume ratio of a portion in which both the content of Co and the total content of M and X fall within specific ranges

### BACKGROUND

The present disclosure relates to a soft magnetic alloy and a magnetic component.

In recent years, there have been demands for low power consumption and higher performance in electronic, information, or communication devices, and so on. Such demands have become even stronger for the realization of a low-carbon society. Thus, reduction in energy loss and improvement in power efficiency are also demanded for a power supply circuit of electronic, information, or communication devices. Further, for a magnetic core of the ceramic element used in the power supply circuit, there are demands for improvement in saturation magnetic flux density and reduction in core loss. By reducing the core loss, the electric energy loss is lowered, and thus higher performance and higher energy conservation can be achieved.

Patent Document 1 discloses that in a nanocrystal alloy including Fe, B, P, and Cu, by controlling various parameters (such as a Cu cluster density, a slope of an Fe concentration near crystal area, and so on) which can be measured using atom probe, the soft magnetic properties of the nanocrystal alloy can be improved.
[Patent Document 1] WO 2021/132254

### SUMMARY

The object of the present disclosure is to provide a soft magnetic alloy achieving a low coercivity Hc and a high saturation magnetic flux density Bs.

In order to achieve the above-mentioned object, a soft magnetic alloy according to the first aspect of the present disclosure, includes:
Fe, Co, and one or more selected from the group consisting of M and X; wherein
M is one or more selected from the group consisting of Ti, V, Cr, Zr, Nb, Mo, Hf, Ta, and W;
X is one or more selected from the group consisting of Si, B, C, and P; and
R(Co4)/R(Fe4)≤0.90 is satisfied, provided that
a content ratio of Fe based on a number of atoms in the soft magnetic alloy is Ave(Fe), a content ratio of Co based on a number of atoms in the soft magnetic alloy is Ave(Co), and a total content ratio of M and X based on a number of atoms in the soft magnetic alloy is Ave(M+X),
a volume ratio of a part where a content ratio of Fe is Ave(Fe) or larger and a total content ratio of M and X is less than Ave(M+X) is R(Fe4), and
a volume ratio of a part where a content ratio of Co is Ave(Co) or larger and a total content ratio of M and X is less than Ave (M+X) is R(Co4).

In order to achieve the above-mentioned object, a soft magnetic alloy according to the second aspect of the present disclosure, includes:
Fe, Co, and one or more selected from the group consisting of M and X, wherein;
M is one or more selected from the group consisting of Ti, V, Cr, Zr, Nb, Mo, Hf, Ta, and W;
X is one or more selected from the group consisting of Si, B, C, and P; and
{R(Co1)+R(Co3)}/{R(Fe1)+R(Fe3)}≥1.53 is satisfied, provided that
a content ratio of Fe based on a number of atoms in the soft magnetic alloy is Ave(Fe), a content ratio of Co based on a number of atoms in the soft magnetic alloy is Ave(Co), and a total content ratio of M and X based on a number of atoms in the soft magnetic alloy is Ave(M+X),
a volume ratio of a part where a content ratio of Fe is Ave(Fe) or larger and a total content ratio of M and X is Ave(M+X) or larger is R(Fe1),
a volume ratio of a part where a content ratio of Fe is less than Ave(Fe) and a total content ratio of M and X is less than Ave(M+X) is R(Fe3),
a volume ratio of a part where a content ratio of Co is Ave(Co) or larger and a total content ratio of M and X is Ave(M+X) or larger is R(Co1), and
a volume ratio of a part where a content ratio of Co is less than Ave(Co) and a total content ratio of M and X is less than Ave(M+X) is R(Co3).

Followings are common in both the first and second aspects of the present disclosure.

The soft magnetic alloy may be a ribbon form.

The soft magnetic alloy may be a powder form.

A magnetic component according to the present disclosure includes the above-mentioned soft magnetic alloy.

### BRIEF DESCRIPTION DRAWINGS

FIG. 1 is an observation result of Fe distribution using 3DAP.

FIG. 2 is an observation result of Co distribution using 3DAP.

FIG. 3 shows a graph in which a content ratio of Fe and a total content ratio of M and X in each grid are plotted.

FIG. 4 shows a graph in which a content ratio of Co and a total content ratio of M and X in each grid are plotted.

FIG. 5 is a schematic image of a single roll method.

FIG. 6 is a schematic image of a heat press treatment.

### DETAILED DESCRIPTION

### First Embodiment

Hereinbelow, the first embodiment of the present disclosure is described.

A soft magnetic alloy according to the present embodiment includes Fe, Co, and one or more selected from the group consisting of M and X.

M is one or more selected from the group consisting of Ti, V, Cr, Zr, Nb, Mo, Hf, Ta, and W. M may be one or more selected from the group consisting of Zr, Nb, and Ta. X is one or more selected from the group consisting of Si, B, C, and P.

The soft magnetic alloy may further include one or more selected from the group consisting of A and D. A is one or more selected from the group consisting of Al, Ga, Ag, Zn, S, Ca, Mg, V, Sn, As, Sb, Bi, N, 0, Au, Cu, and rare earth elements. The rare earth elements may be Sc, Y, and lanthanoids. A may be Cu. D is one or more selected from the group consisting of Ni and Mn.

The soft magnetic alloy may mainly include Fe and Co. Specifically, a total content ratio of Fe and Co in the soft magnetic alloy may be 60 at % or more.

A content ratio of Fe based on the number of atoms in the soft magnetic alloy is Ave(Fe), a content ratio of Co based on the number of atoms in the soft magnetic alloy is Ave(Co), and a total content ratio of M and X based on the number of atoms in the soft magnetic alloy is Ave(M+X). Further, a volume ratio of a part where a content of Fe is Ave(Fe) or larger and a total content of M and X is less than Ave(M+X) is R(Fe4); and a volume ratio of a part where a content of Co is Ave(Co) or larger and a total content ratio of M and X is less than Ave(M+X) is R(Co4).

The soft magnetic alloy satisfies R(Co4)/R(Fe4)≤0.90.

In below, a method of measuring R(Co4)/R(Fe4) is described.

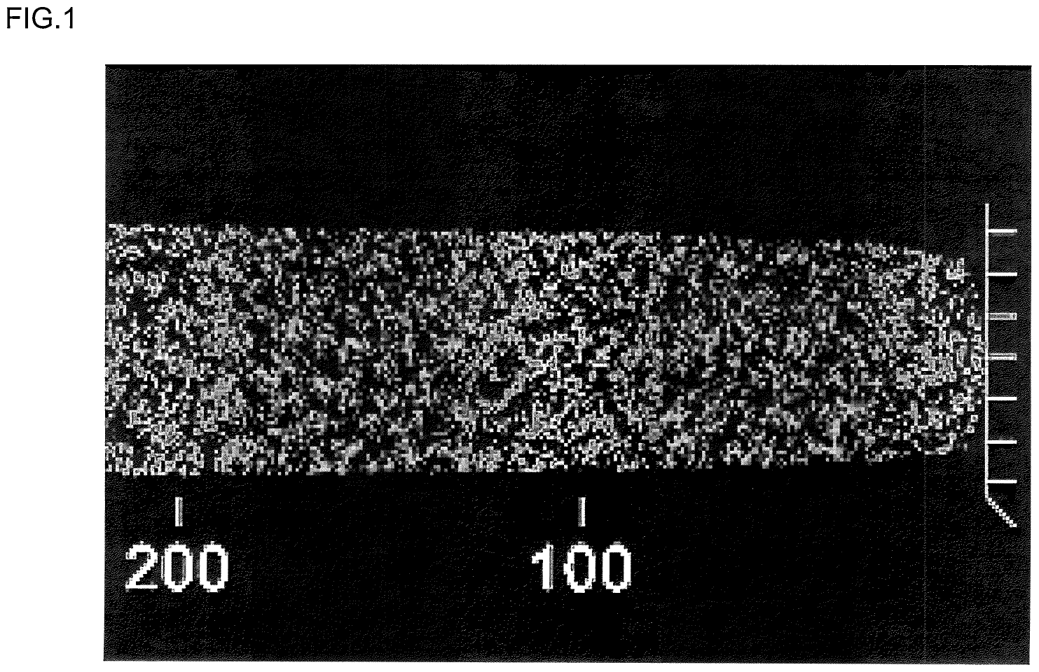

When a Fe distribution at a part which is 100 nm deep from a surface of the soft magnetic alloy is observed using three dimension atom probe (hereinbelow, it may be described as 3DAP), a part with a large amount of Fe and a part with a small amount of Fe can be observed, as shown in FIG. 1.

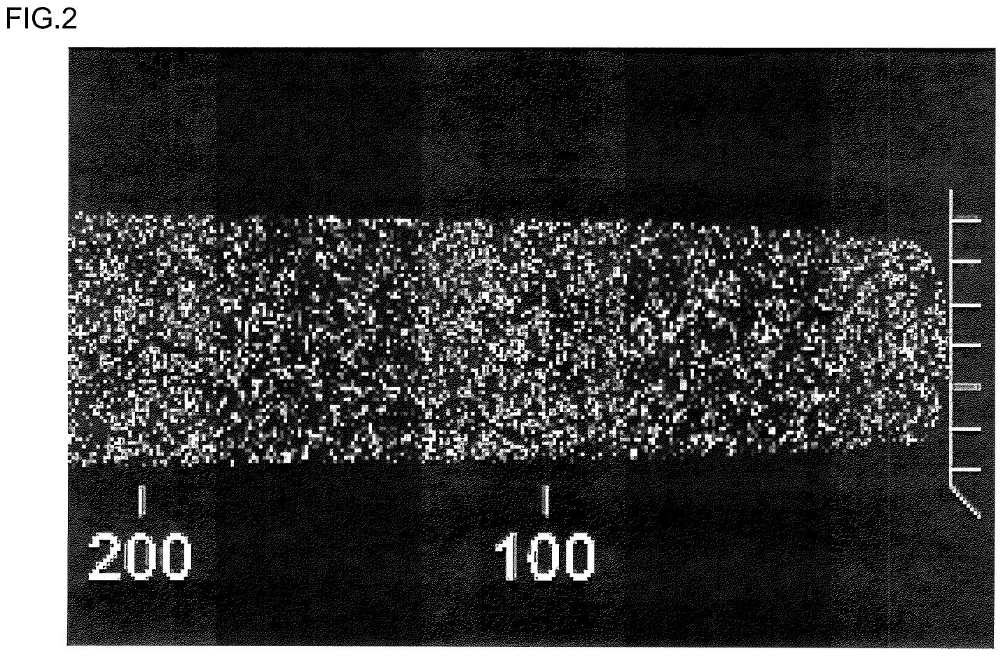

When a Co distribution in the soft magnetic alloy at a part which is 100 nm deep from the surface of the soft magnetic alloy is observed using 3DAP, a part with a large amount of Co and a part with a small amount of Co can be observed, as shown in FIG. 2.

The soft magnetic alloy used for measuring R(Co4)/R(Fe4) is processed into a needle form and 3DAP analysis is performed, an observation area is set within the data group of the obtained needle form. A dimension of the observation area is not particularly limited, and preferably it may be 3200 nm² or larger, more preferably 10000 nm² or larger. A shape of the observation area is not particularly limited. For example, it may be a rectangular parallelpiped shape of 10 nm×10 nm×200 nm.

The observation area is then divvied into a cuboid grid of 2 nm×2 nm×2 nm. The number of grids is at least 400. For example, if the shape of the observation area is a rectangular parellelpiped shape of 10 nm×10 nm×200 nm, then the observation area is divided into 2500 grids.

Then, a content ratio of each element in each grid is measured. Further, it is verified whether each grid is a part where the content ratio of Fe is Ave(Fe) or larger and a total content ratio of M and X is less than Ave(M+X). At the same time, it is verified whether a grid is a part where the content ratio of Co is Ave(Co) or larger and a total content ratio of M and X is less than Ave(M+X).

Ave(Fe), Ave(Co), and Ave(M+X) in the above-mentioned soft magnetic alloy are respectively a composition which is obtained by taking an average of compositions of entire grids.

Note that, the part where the content ratio of Fe is Ave(Fe) or larger and a total content ratio of M and X is less than Ave(M+X) may also be the part where the content ratio of Co is Ave(Co) or larger and a total content ratio of M and X is less than Ave(M+X).

Then, the number of grids where the content ratio of Co is Ave(Co) or larger and a total content ratio of M and X is less than Ave(M+X) is divided by the number of grids where the content ratio of Fe is Ave(Fe) or larger and a total content ratio of M and X is less than Ave(M+X). The obtained value is R(Co4)/R(Fe4).

A value obtained by converting a value of each element belonging to a population so that an average is 0 and a standard deviation is 1 may be called a z-value.

A z-value obtained by converting a content ratio of Fe in each grid so that an average is 0 and a standard deviation is 1 is defined as z(Fe). A z-value obtained by converting a content ratio of Co in each grid so that an average is 0 and a standard deviation is 1 is defined as z(Co). A z-value obtained by converting a total content ratio of M and X in each grid so that an average is 0 and a standard deviation is 1 is defined as z(M+X).

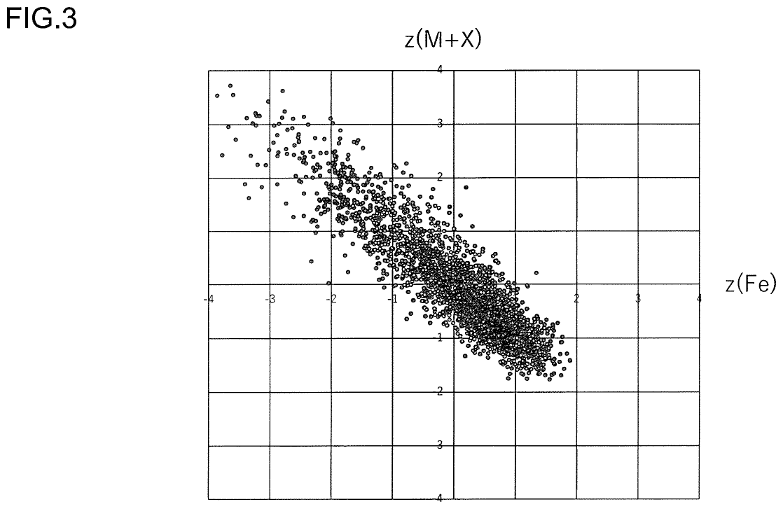

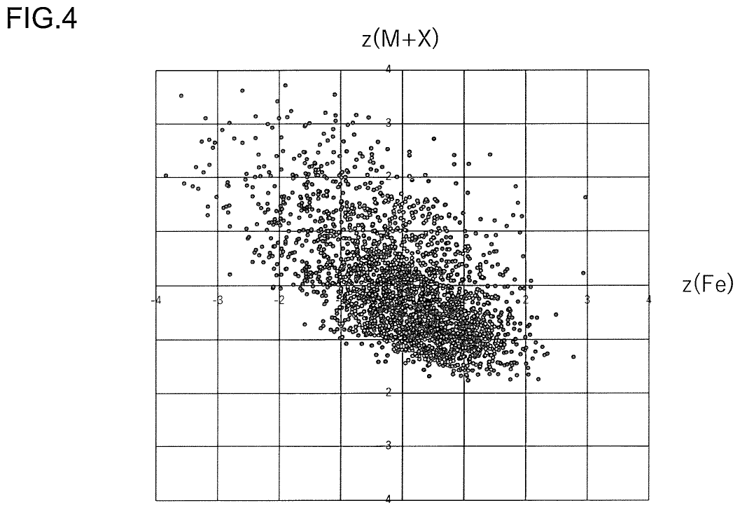

In the graph shown in FIG. 3, the content ratio of Fe and the total content ratio of M and X in each grid are plotted where z(Fe) is a horizontal axis and z(M+X) is a vertical axis. In the graph shown in FIG. 4, the content ratio of Co and the total content ratio of M and X in each grid are plotted in the graph where z(Co) is a horizontal axis and z(M+X) is a vertical axis. The number of dots shown in FIG. 3 is the same as the number of dots shown in FIG. 4.

R(Fe4) is a ratio of the number of dots included in the 4th quadrant or a part where z(Fe)=0 and z(M+X)<0 to the number of dots in FIG. 3. R(Co4) is a ratio of the number of dots included in the 4th quadrant of FIG. 4 or a part where z(Co)=0 and z(M+X)<0 to the number of dots in FIG. 4.

M and X are components known as amorphization components. The larger R(Fe4) is, the larger the part where Fe is separated from M and X. The larger the R(Co4) is, the larger the part where Co is separated from M and X.

That is, the smaller R(Co4)/R(Fe4) is, the higher the separation degree of Fe and the amorphization components compared to that of Co and the amorphization components. The present inventors have found that by having higher separation degree of Fe and the amorphization components than the separation degree of Co and the amorphization components, a magnetostriction decreases, thus Hc decreases and Bs increases.

The lower limit of R(Co4)/R(Fe4) is not particularly limited, and for example, it may be R(Co4)/R(Fe4)≥0.50. From the point of magnetic properties, it is preferably R(Co4)/R(Fe4)≥0.60, and more preferably it is R(Co4)/R(Fe4)≥0.70.

R(Fe4) and R(Co4) are not particularly limited. For example, R(Fe4) may be within a range of 0.30≤R(Fe4)≤0.60, or may be within a range of 0.20≤R(Co4)≤0.50.

Note that, the soft magnetic alloy may also satisfy {R(Co1)+R(Co3)}/{R(Fe1)+R(Fe3)}≥1.53. When the soft magnetic alloy satisfies R(Co4)/R(Fe4)≤0.90 but is {R(Co1)+R(Co3)}/{R(Fe1)+R(Fe3)}<1.53, Hc tends to become high. A method of measuring {R(Co1)+R(Co3)}/{R(Fe1)+R(Fe3)} is described in the second embodiment.

The composition of the soft magnetic alloy according to the present embodiment is not particularly limited except for including Fe and Co, and also including one or more selected from the group consisting of M and X. Further, one or more selected from the group consisting of A and D may not be included.

For example, the soft magnetic alloy according to the present embodiment may be expressed by a compositional formula of Fe₁₋₍α₊β₎CoαAβ)_{1-(m+x+d)}MₘXₓD_{d} which is based on the ratio of number of atoms, in which

$$0 \leq m \leq 0.1 \; 20 ,$$

$$0 \leq x \leq 0.2 \; 10 ,$$

$$0 < m + x \leq 0.3 \; 30 ,$$

$$0 \leq d \leq 0.0 \; 50 ,$$

$$0.05 \leq α \leq 0.5 , and$$

$$0 \leq β \leq 0.0 \; 50 may be satisfied .$$

A method of measuring the composition of the soft magnetic alloy is not particularly limited; that is, a method of measuring the types of above-mentioned A, M, X, and D; and the values of m, x, d, a, and p is not particularly limited. For example, methods such as X-ray Fluorescence Spectrometry (XRF), Inductively Coupled Plasma Atomic Emission Spectroscopy (ICP-AES), Energy Dispersive X-ray Spectroscopy (EDS), and Electron Energy Loss Spectroscopy (EELS) can be used.

When the composition of the soft magnetic alloy is within the above-mentioned range, Hc of the soft magnetic alloy may decrease easily.

A content of elements other than mentioned in the above, that is, the content of elements other than Fe, Co, M, X, A, and D may be 0.1 mass % or less.

A content (m) of M may be within a range of 0≤m≤0.110, or may be within a range of 0.020≤m≤0.110.

A content (x) of X may be within a range of 0.030≤x≤0.210. Also, x may be 0.200 or less.

A content (d) of D may be within a range of 0≤d≤0.030, may be within a range of 0.005≤d≤0.030, or may be within a range of 0.010≤d≤0.030. Particularly, when 0.005≤d≤0.030, the separation degree of Fe and the amorphization components becomes even higher, and Hc tends to decrease even more. Also, crystals tend to deposit easily in the soft magnetic alloy, and Bs tends to increase even more.

A content (α) of Co to a total content of Fe, Co, and A may be within a range of 0.050≤α≤0.350.

A content (β) of A to the total content of Fe, Co, and A may be within a range of 0≤β≤0.020.

Hereinafter, a method of producing the soft magnetic alloy according to the present embodiment is described.

A method of producing the soft magnetic alloy according to the present embodiment is not particularly limited. For example, a method of producing the soft magnetic alloy ribbon using a single roll method may be mentioned.

In the single roll method, first, various raw materials of pure metals of metal elements included in the soft magnetic alloy obtained at the end are prepared. Then, the raw materials are weighed so that these are the same as the composition of the soft magnetic alloy obtained at the end. Then, the pure metals of metal elements are melted, and mixed to produce a mother alloy. Note that, a method of melting the pure metals is not particularly limited, and for example, it may be a method of melting the pure metals using a high frequency heating after vacuuming inside of the chamber. Note that, the mother alloy and the soft magnetic alloy obtained at the end usually have the same compositions.

Next, the obtained mother alloy is heated and melted to produce a molten metal (molten). A temperature of the molten metal is not particularly limited, and for example, it may be within a range of 1200 and 1500° C.

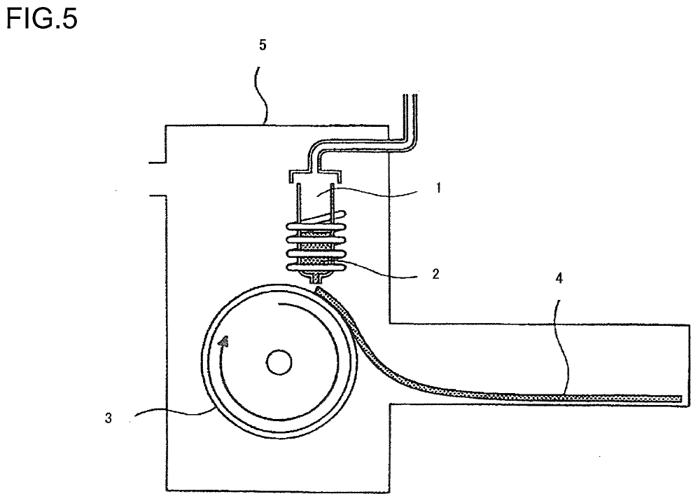

A schematic diagram of a device used in the single roll method is shown in FIG. 5. In regards with the single roll method according to the present embodiment, in the chamber 5, the molten metal 2 is sprayed and supplied from the nozzle 1 to a roll 3 which is rolling in a direction indicated by an arrow, thereby, a ribbon 4 is produced along the rolling direction of the roll 3. Note that, a material of the roll 3 in the present embodiment is not particularly limited. For example, a roll made of Cu is used.

In the single roll method, a thickness of the ribbon can be adjusted mainly by adjusting a rotational speed of the roll 3, furthermore the thickness of the ribbon can be adjusted by adjusting a space between the nozzle 1 and the roll 3, and also by adjusting the temperature of the molten metal. The thickness of the ribbon is not particularly limited, and for example, it can be within a range of 15 to 30 μm.

Here, the present inventors have found that by appropriately regulating the temperature of the roll 3 and a vapor pressure inside the chamber 5, it tends to be easier to achieve a preferable distribution of a content ratio of each element in the obtained soft magnetic alloy after a heat press treatment, which is described in below. Further, the present inventors have found that Bs of the soft magnetic alloy obtained after the heat press treatment tends to be higher and also Hc tends to be lower.

Regarding the temperature of the roll 3, it may be within a range of 30 to 70° C., or preferably it may be within a range of 30 to 50° C.

An atmosphere inside the chamber 5 is not particularly limited. For example, it may be a vacuumed atmosphere or in the air. Also, it may be in argon atmosphere in which the vapor pressure is regulated by dew point adjustment. As for the vapor pressure, it is not particularly limited.

By heat treating the obtained ribbon 4, it tends to be easier to achieve a preferable distribution of a content ratio of each element in the obtained soft magnetic alloy after the heat press treatment.

Heat treatment conditions may change depending on the composition of the soft magnetic alloy, a heat treatment temperature may be 400° C. or higher and 550° C. or lower, or may be 425° C. or higher and 525° C. or lower. From the point of easily satisfying {R(Co1)+R(Co3)}/{R(Fe1)+R(Fe3)}≥1.53, the heat treatment temperature may be 475° C. or higher and 525° C. or lower. Preferably, the heat treatment time may be 0.05 hours or longer and 5 hours or shorter, and more preferably 1.0 hour or longer and 1.5 hours or shorter. The atmosphere during the heat treatment is not particularly limited. For example, it may be atmosphere close to a vacuumed atmosphere.

By carrying out heat press treatment to the soft magnetic alloy after the heat treatment, a preferable distribution of the content ratio of each element in the soft magnetic alloy can achieved.

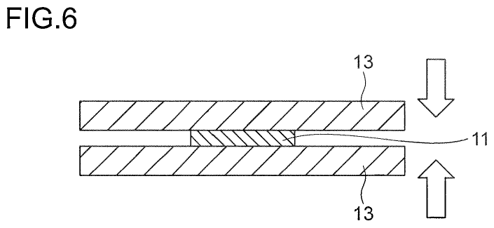

A schematic image of the heat press treatment is shown in FIG. 6. For the heat press treatment, a press plate 13 is heated in advance. Then, pressure is applied to the heat treated soft magnetic alloy 11 using the press plate 13 in the direction shown by an arrow, and this condition is maintained. By appropriately regulating the temperature of the press plate 13 (hereinafter, such temperature may be simply referred to as “a press temperature”), a pressure during heat pressing (hereinafter, such pressure may be simply referred to as “a press pressure”), and a time held under the pressure of heat pressing (hereinafter, such time may be simply referred to as “a press time”), a preferable distribution of the content ratio of each element in the soft magnetic alloy 11 can achieved.

A shape of the soft magnetic alloy 11 subject to the heat press treatment is not particularly limited. The ribbon form soft magnetic alloy 11 may be directly heat press treated, or the ribbon form soft magnetic alloy may be processed according to the type of the heat press treatment device.

In FIG. 6, the soft magnetic alloy 11 is pressed from both sides using two press plates 13, but pressure may be applied only from one side. Also, preferably, two press plates 13 are heated, however, only one of the press plates 13 may be heated. Also, the temperatures of the two press plates 13 may be the same or may be different.

The press temperature is not particularly limited, and it may be within a range of 350° C. to 425° C. The press pressure is not particularly limited, and it may be within a range of 0.2 to 1.0 MPa. The press time is not particularly limited, and it may be within a range of one minute to 60 minutes. Note that, when the press temperature is too low (for example, when it is lower than 350° C.), when the press pressure is too low (for example, when it is lower than 0.2 MPa), and/or when the press time is short (for example shorter than 1 minute), movement of each element does not occur sufficiently, thus it is difficult to regulate the distribution of a content ratio of each element. Also, when the press temperature is high (for example, when it is higher than 425° C.), coarse crystal grains are easily formed, thus, Hc tends to increase. Also, when the press pressure is high (for example, when it is higher than 1.0 MPa), a residual stress tends to remain in the soft magnetic alloy even after the heat press, thus, Hc tends to increase.

Also, as a method of obtaining the soft magnetic alloy according to the present embodiment, other than the single roll method mentioned in above, for example, a water atomization method or a gas atomization method may be used as the method of obtaining a powder of the soft magnetic alloy according to the present embodiment. In below, a gas atomization method is described.

In a gas atomization method, similar to the single roll method mentioned above, a molten alloy of 1200 to 1500° C. is obtained. Then, the molten alloy is sprayed in the chamber, and then the powder is produced.

A gas temperature may preferably be within a range of 4 to 100° C., or more preferably 4 to 30° C.

Atmosphere inside the chamber 5 is not particularly limited. For example, it may be a vacuumed atmosphere or in the air. Also, the atmosphere may be argon atmosphere in which the vapor pressure is regulated by dew point adjustment. The vapor pressure is not particularly limited.

After producing the powder using a gas atomization method, by carrying out the heat treatment similar to the case of a single roll method, it becomes easier to decrease R(Co4)/R(Fe4) and to increase {R(Co1)+R(Co3)}/{R(Fe1)+R(Fe3)}. Note that, a method of obtaining the powder is not necessarily limited to an atomization method. For example, the soft magnetic alloy powder obtained using a single roll method may be pulverized to obtain the powder.

The heat treatment conditions may change depending on the composition of the soft magnetic alloy. For example, A heat treatment temperature may be within a range of 400° C. or higher and 550° C. or lower, 425° C. or higher and 525° C. or lower, or 475° C. or higher and 525° C. or lower. A heat treatment time may be within a range of 0.05 hours or longer and 5 hours or shorter, or preferably it may be within a range of 1.0 hour or longer and 1.5 hours or shorter. Atmosphere during the heat treatment is not particularly limited, and it may be atmosphere close to a vacuumed atmosphere.

By carrying out the heat press treatment to the heat treated soft magnetic alloy, a preferable distribution of the content ratio of each element in the soft magnetic alloy can be achieved.

In the case of carrying out the heat press treatment to the soft magnetic alloy of powder form, heat and pressure may be applied to the heat treated soft magnetic alloy of powder form. For example, the heat press treatment may be carried out using a mold for powder molding. By appropriately regulating the press temperature, the press pressure, and the press time, R(Co4)/R(Fe4) of the soft magnetic alloy 11 decreases and {R(Co1)+R(Co3)}/{R(Fe1)+R(Fe3)} of the soft magnetic alloy 11 increases.

The press temperature is not particularly limited, and it may be within a range of 350 to 425° C. The press pressure is not particularly limited, and it may be within a range of 0.2 to 1.0 MPa. The press time is not particularly limited, and it may be within a range of 1 to 60 minutes. Note that, when the press temperature is too low (for example, when it is lower than 350° C.), when the press pressure is low (for example, when it is lower than 0.2 MPa), and/or when the press time is short (for example shorter than 1 minute), movement of each element does not sufficiently occur; thus, it is difficult to regulate the distribution of a content ratio of each element. Also, when the press temperature is high (for example, when it is higher than 425° C.), coarse crystal grains are easily formed, thus, Hc tends to increase. Also, when the press pressure is high (for example, when it is higher than 1.0 MPa), a residual stress tends to remain in the soft magnetic alloy even after the heat press, thus Hc tends to increase.

Hereinabove, one exemplary embodiment of the present disclosure is described, however, the present disclosure is not limited to the above-mentioned embodiment.

The shape of the soft magnetic alloy according to the present embodiment is not particularly limited. As mentioned in above, a ribbon form and a powder form may be mentioned as examples, however, other than these, a thin film form, a block form, and so on may be mentioned.

The use of the soft magnetic alloy according to the present embodiment is not particularly limited. For example, a magnetic component such as a magnetic core or a magnetic head used for such as an inductor, a motor, a transformer, a noise counter component may be mentioned. Since the soft magnetic alloy with low Hc and high Bs is used, a magnetic component capable for being used under large electric power and small electric loss can be obtained.

### Second Embodiment

Hereinbelow, a second embodiment of the present disclosure is described, and the parts which are the same as in the first embodiment may not be mentioned in below.

The content ratio of Fe based on the number of atoms in the soft magnetic alloy is defined as Ave(Fe), the content ratio of Co based on the number of atoms in the soft magnetic alloy is defined as Ave(Co), and the total content ratio of M and X based on the number of atoms in the soft magnetic alloy is defined as Ave(M+X). Further, a ratio of the part where a content ratio of Fe is Ave(Fe) or larger and a total content ratio of M and X is Ave(M+X) or larger is defined as R(Fe1). A part where a content ratio of Fe is less than Ave(Fe) and a total content ratio of M and X is less than Ave(M+X) is defined as R(Fe3). A part where a content ratio of Co is Ave(Co) or larger and a total content ratio of M and X is Ave(M+X) or larger is defined as Ave(Co1). A part where a content ratio of Co is less than Ave(Co) and a total content ratio of M and X is less than Ave(M+X) is defined as R(Co3).

The soft magnetic alloy satisfies {R(Co1)+R(Co3)}/{R(Fe1)+R(Fe3)}≥1.53.

In below, a method of measuring {R(Co1)+R(Co3)}/{R(Fe1)+R(Fe3)} is described. Parts which are the same as the method of measuring R(Fe4)/R(Co4) may not be mentioned in below.

The number of grids where the content ratio of Co is Ave(Co) or larger and the total content ratio of M and X is Ave(M+X) or larger, and the number of grids where the content ratio of Co is less than Ave(Co) and the total content ratio of M and X is less than (M+X) are summed. The number of grids where the content ratio of Fe is Ave(Fe) or larger and the total content ratio of M and X is Ave(M+X) or larger, and the number of grids where the content ratio of Fe is less than Ave(Fe) and the total content ratio of M and X is less than Ave(M+X) are summed. Then, the former number of grids, divided by the latter number of grids, the obtained value is {R(Co1)+R(Co3)}/{R(Fe1)+R(Fe3)}.

In the graph shown in FIG. 3, the horizontal axis is z(Fe) axis and the vertical axis is z(M+X) axis, and the content ratio of Fe and the total content ratio of M and X in each grid are plotted. In the graph shown in FIG. 4, the horizontal axis is z(Co) axis and the vertical axis is z(M+X) axis, and the content ratio of Co and the total content ratio of M and X in each grid are plotted. The number of dots in FIG. 3 and the number of dots in FIG. 4 are the same.

Among all of the dots in FIG. 3, R(Fe1) is a total ratio of the number of dots included in any one of the first quadrant, the part which is z(Fe)=0 and z(M+X)>0, the part which is z(Fe)>0 and z(M+X)=0, and z(Fe)=z(M+X)=0. The ratio of the number of dots included in the third quadrant of FIG. 3 is R(Fe3).

Among all of the dots in FIG. 4, R(Co1) is a total ratio of the number of dots included in any one of the first quadrant, the part which is z(Co)=0 and z(M+X)>0, the part which is z(Co)>0 and z(M+X)=0, and z(Co)=z(M+X)=0. The ratio of the number of dots included in the third quadrant of FIG. 4 is R(Co3).

M and X are components known as amorphization components. The smaller R(Fe1)+R(Fe3) is, the larger the part where Fe is separated from M and X. The larger R(Co1)+R(Co3) is, the smaller the part where Co is separated from M and X.

That is, the larger {R(Co1)+R(Co3)}/{R(Fe1)+R(Fe3)} is, the lower the separation degree between Co and the amorphization components is compared to the separation degree between Fe and the amorphization components. The present inventors have found that by having a lower separation degree between Co and the amorphization components compared to the separation degree between Fe and amorphization components, magnetostriction decreases, thus Hc decreases and also Bs increases.

There is no particular upper limit of {R(Co1)+R(Co3)}/{R(Fe1)+R(Fe3)}. For example, it may be {R(Co1)+R(Co3)}/{R(Fe1)+R(Fe3)}≤6.00. From the point of magnetic properties, preferably it may be {R(Co1)+R(Co3)}/{R(Fe1)+R(Fe3)}≤4.00, and particularly preferably {R(Co1)+R(Co3)}/{R(Fe1)+R(Fe3)}≤2.90.

Also, {R(Co1)+R(Co3)} and {R(Fe1)+R(Fe3)} are not particularly limited. For example, it may be 0.20≤{R(Co1)+R(Co3)}≤0.50 and 0.05≤{R(Fe1)+R(Fe3)}≤0.40.

Note that, it may be R(Co4)/R(Fe4)≤0.90. When {R(Co1)+R(Co3)}/{R(Fe1)+R(Fe3)}≥1.53 and R(Co4)/R(Fe4)>0.90, Bs tends to be low. The method of measuring R(Co4)/R(Fe4) is already discussed in the first embodiment.

### EXAMPLES

In below, the present disclosure is described in details using the examples.

### Experiment Example 1

Various raw material metals were weighed to obtain mother alloys satisfying compositions shown in each table. Then, inside of a chamber was vacuumed, and the raw material metals were melted using high frequency heating and the mother alloys were produced.

Then, the produced mother alloy was melted to form molten metal of a temperature of 1250° C., and the metal was sprayed on the roll to form a ribbon using a single roll method. A temperature of the roll was 30° C., and the condition inside the chamber was made close to the vacuumed condition. Also, by appropriately adjusting a rotational speed of the roll, the obtained ribbon had a thickness of 20 μm.

Next, heat treatment was performed to a produced ribbon, and a sample of a plate form was obtained. A heat treatment temperature for each sample is indicated in each table. A heat treatment time was 1 hour. The condition inside the chamber during the heat treatment was made close to the vacuumed condition, and a vapor pressure inside the chamber was 1 hPa or less. Samples in Table 1 to Table 3 with no description regarding the heat treatment temperature means that the heat treatment was not carried out for those samples. For all of examples and comparative examples shown in Table 4A, Table 4B, and Table 5, the heat treatment temperature was 525° C.

Next, a heat press treatment was carried out to the heat treated sample of plate form. A press temperature and a press pressure are shown in each table. A press time was 10 minutes, and atmosphere inside the chamber during the heat press treatment was in the air. For all of the examples shown in Table 4A, Table 4B, and Table 5, the press temperature was 400° C., and the press pressure was 0.5 MPa.

Samples in Tables 1 to 9 without description of the heat press treatment are the samples which were not carried out with the heat press treatment. Comparative example 3 is a sample which was heat treated at 525° C. for 60 minutes and then heat treated at 400° C. for 10 minutes; that is, the heat press treatment was not carried out in Comparative example 3. Comparative example 4 was heat press treated at the press temperature of 30° C. That is, Comparative example 4 was a sample which was press treated substantially without heating. Comparative example 5 is a sample that the order of the heat press treatment and the heat treatment of Example 3 was reversed.

Regarding each of the obtained samples, an observation area of 10 nm×10 nm×200 nm was observed using 3DAP. The observation field was divided into 2500 cubic grids of 2 nm×2 nm×2 nm. Then, the content ratio of each element in each grid was measured. The composition obtained by taking the average of content ratio of each element in all of the grids was confirmed to match the composition shown in each table.

Then, R(Co4)/R(Fe4) and {R(Co1)+R(Co3)}/{R(Fe1)+R(Fe3)} were calculated. Results are shown in each table.

For each sample, Bs and Hc were measured. Specifically, Bs was measured at a magnetic field of 1000 kA/m using a Vibrating Sample Magnetometer (VSM). Also, He was measured using a Hc meter. Results are shown in each table. When Bs was 1.40 T or more, it was considered good. Further, Hc of 12.5 A/m or less was considered good, less than 7.0 A/m was considered even better, and less than 5.0 A/m was considered particularly good.

TABLE 1

| | Soft magnetic alloy composition | | | | | | | | | | |
|---|---|---|---|---|---|---|---|---|---|---|---|
| | (Fe_{1-(α+β)}Co_{α}A_{β})_{1-(m+x+d)}MₘXₓD_{d} d = 0 | | | | | | | | | | |
| | Fe | | Co | | A | | | | | Xₓ = X1ₓ₁X2ₓ₂X3ₓ₃ | |
| | (1 − (α + β)) × | | α × | | | β × | | M | | (x = x1 + x2 + x3) | |
| | (1 − (m + x + d)) | 1 − (α + β) | (1 − (m + X + d)) | α | A | (1 − (m + x + d)) | β | M | m | X1 | x1 |
| Example 1 | 0.546 | 0.650 | 0.294 | 0.350 | — | 0.000 | 0.000 | Nb | 0.075 | B | 0.050 |
| Example 2 | 0.546 | 0.650 | 0.294 | 0.350 | — | 0.000 | 0.000 | Nb | 0.075 | B | 0.050 |
| Example 3 | 0.546 | 0.650 | 0.294 | 0.350 | — | 0.000 | 0.000 | Nb | 0.075 | B | 0.050 |
| Example 4 | 0.546 | 0.650 | 0.294 | 0.350 | — | 0.000 | 0.000 | Nb | 0.075 | B | 0.050 |
| Example 5 | 0.546 | 0.650 | 0.294 | 0.350 | — | 0.000 | 0.000 | Nb | 0.075 | B | 0.050 |
| Example 3 | 0.546 | 0.650 | 0.294 | 0.350 | — | 0.000 | 0.000 | Nb | 0.075 | B | 0.050 |
| Example 6 | 0.546 | 0.650 | 0.294 | 0.350 | — | 0.000 | 0.000 | Nb | 0.075 | B | 0.050 |
| Example 3 | 0.546 | 0.650 | 0.294 | 0.350 | — | 0.000 | 0.000 | Nb | 0.075 | B | 0.050 |
| Comparative | 0.546 | 0.650 | 0.294 | 0.350 | — | 0.000 | 0.000 | Nb | 0.075 | B | 0.050 |
| example 1 | | | | | | | | | | | |
| Comparative | 0.546 | 0.650 | 0.294 | 0.350 | — | 0.000 | 0.000 | Nb | 0.075 | B | 0.050 |
| example 2 | | | | | | | | | | | |
| Comparative | 0.546 | 0.650 | 0.294 | 0.350 | — | 0.000 | 0.000 | Nb | 0.075 | B | 0.050 |
| example 3 | | | | | | | | | | | |
| Comparative | 0.546 | 0.650 | 0.294 | 0.350 | — | 0.000 | 0.000 | Nb | 0.075 | B | 0.050 |
| example 4 | | | | | | | | | | | |
| Comparative | 0.546 | 0.650 | 0.294 | 0.350 | — | 0.000 | 0.000 | Nb | 0.075 | B | 0.050 |
| example 5 | | | | | | | | | | | |

| | | | | | Heat | | | | | | |
|---|---|---|---|---|---|---|---|---|---|---|---|
| | Soft magnetic alloy composition | | | | treatment | Heat press | | | | | |
| | (Fe_{1-(α+β)}Co_{α}A_{β})_{1-(m+x+d)}MₘXₓD_{d} | | | | condition | treatment | | | | | |
| | d = 0 | | | | Heat | condition | | | {R(Co1) + | Magnetic | |
| | Xₓ = X1ₓ₁X2ₓ₂X3ₓ₃ | | | | treatment | Pres | Press | | R(Co3)}/ | properties | |
| | (x = x1 + x2 + x3) | | | | Temp. | Temp. | pressure | R(Co4)/ | {R(Fe1) + | Bs | Hc |
| | X2 | x2 | X3 | x3 | ° C. | ° C. | MPa | R(Fe4) | R(Fe3)} | (T) | (A/m) |
| Example 1 | P | 0.035 | — | 0.000 | 525 | 350 | 0.5 | 0.90 | 1.56 | 1.67 | 12.1 |
| Example 2 | P | 0.035 | — | 0.000 | 525 | 375 | 0.5 | 0.86 | 1.99 | 1.69 | 6.8 |
| Example 3 | P | 0.035 | — | 0.000 | 525 | 400 | 0.5 | 0.83 | 2.22 | 1.70 | 3.3 |
| Example 4 | P | 0.035 | — | 0.000 | 525 | 425 | 0.5 | 0.82 | 2.30 | 1.70 | 3.1 |
| Example 5 | P | 0.035 | — | 0.000 | 525 | 400 | 0.2 | 0.88 | 1.65 | 1.70 | 12.5 |
| Example 3 | P | 0.035 | — | 0.000 | 525 | 400 | 0.5 | 0.83 | 2.22 | 1.70 | 3.3 |
| Example 6 | P | 0.035 | — | 0.000 | 525 | 400 | 1.0 | 0.82 | 2.31 | 1.70 | 3.0 |
| Example 3 | P | 0.035 | — | 0.000 | 525 | 400 | 0.5 | 0.83 | 2.22 | 1.70 | 3.3 |
| Comparative | P | 0.035 | — | 0.000 | 525 | — | — | 0.98 | 1.03 | 1.62 | 14.7 |
| example 1 | | | | | | | | | | | |
| Comparative | P | 0.035 | — | 0.000 | — | 400 | 0.5 | 1.01 | 1.05 | 1.58 | 18.8 |
| example 2 | | | | | | | | | | | |
| Comparative | P | 0.035 | — | 0.000 | 525 | 400 | 0.0 | 0.98 | 1.20 | 1.62 | 14.2 |
| example 3 | | | | | | | | | | | |
| Comparative | P | 0.035 | — | 0.000 | 525 | 30 | 0.5 | 0.97 | 1.15 | 1.63 | 14.5 |
| example 4 | | | | | | | | | | | |
| Comparative | P | 0.035 | — | 0.000 | 525 | 400 | 0.5 | 0.96 | 1.35 | 1.65 | 14.0 |
| example 5 | | | | | | | | | | | |

TABLE 2

| | Soft magnetic alloy composition | | | | | | | | | | |
|---|---|---|---|---|---|---|---|---|---|---|---|
| | (Fe_{1-(α+β)}Co_{α}A_{β})_{1-(m+x+d)}MₘXₓD_{d} d = 0 | | | | | | | | | | |
| | Fe | | Co | | A | | | | | Xₓ = X1ₓ₁X2ₓ₂X3ₓ₃ | |
| | (1 − (α + β)) × | | α × | | | β × | | M | | (x = x1 + x2 + x3) | |
| | (1 − (m + x + d)) | 1 − (α + β) | (1 − (m + X + d)) | α | A | (1 − (m + x + d)) | β | M | m | X1 | x1 |
| Example 9 | 0.420 | 0.500 | 0.420 | 0.500 | — | 0.000 | 0.000 | Nb | 0.075 | B | 0.050 |
| Example 3 | 0.546 | 0.650 | 0.294 | 0.350 | — | 0.000 | 0.000 | Nb | 0.075 | B | 0.050 |
| Example 7 | 0.672 | 0.800 | 0.168 | 0.200 | — | 0.000 | 0.000 | Nb | 0.075 | B | 0.050 |
| Example 8 | 0.798 | 0.950 | 0.042 | 0.050 | — | 0.000 | 0.000 | Nb | 0.075 | B | 0.050 |
| Example 8a | 0.798 | 0.950 | 0.042 | 0.050 | — | 0.000 | 0.000 | Nb | 0.075 | B | 0.050 |
| Example 8b | 0.798 | 0.950 | 0.042 | 0.050 | — | 0.000 | 0.000 | Nb | 0.075 | B | 0.050 |
| Example 7a | 0.672 | 0.800 | 0.168 | 0.200 | — | 0.000 | 0.000 | Nb | 0.075 | B | 0.050 |
| Comparative | 0.420 | 0.500 | 0.420 | 0.500 | — | 0.000 | 0.000 | Nb | 0.075 | B | 0.050 |
| example 101 | | | | | | | | | | | |
| Comparative | 0.798 | 0.950 | 0.042 | 0.050 | — | 0.000 | 0.000 | Nb | 0.075 | B | 0.050 |
| example 102 | | | | | | | | | | | |

| | | | | | Heat | | | | | | |
|---|---|---|---|---|---|---|---|---|---|---|---|
| | Soft magnetic alloy composition | | | | treatment | Heat press | | | | | |
| | (Fe_{1-(α+β)}Co_{α}A_{β})_{1-(m+x+d)}MₘXₓD_{d} | | | | condition | treatment | | | | | |
| | d = 0 | | | | Heat | condition | | | {R(Co1) + | Magnetic | |
| | Xₓ = X1ₓ₁X2ₓ₂X3ₓ₃ | | | | treatment | Press | Press | | R(Co3)}/ | properties | |
| | (x = x1 + x2 + x3) | | | | Temp. | Temp. | pressure | R(Co4)/ | {R(Fe1) + | Bs | Hc |
| | X2 | x2 | X3 | x3 | ° C. | ° C. | MPa | R(Fe4) | R(Fe3)} | (T) | (A/m) |
| Example 9 | P | 0.035 | — | 0.000 | 525 | 400 | 0.5 | 0.90 | 1.53 | 1.66 | 7.0 |
| Example 3 | P | 0.035 | — | 0.000 | 525 | 400 | 0.5 | 0.83 | 2.22 | 1.70 | 3.3 |
| Example 7 | P | 0.035 | — | 0.000 | 525 | 400 | 0.5 | 0.75 | 2.98 | 1.68 | 3.0 |
| Example 8 | P | 0.035 | — | 0.000 | 525 | 400 | 0.5 | 0.62 | 3.65 | 1.62 | 2.9 |
| Example 8a | P | 0.035 | — | 0.000 | 525 | 400 | 1.0 | 0.58 | 3.91 | 1.59 | 2.8 |
| Example 8b | P | 0.035 | — | 0.000 | 525 | 425 | 1.0 | 0.51 | 4.03 | 1.56 | 2.8 |
| Example 7a | P | 0.035 | — | 0.000 | 425 | 400 | 0.5 | 0.76 | 1.52 | 1.59 | 5.0 |
| Comparative | P | 0.035 | — | 0.000 | 525 | — | — | 1.02 | 1.22 | 1.64 | 14.5 |
| example 101 | | | | | | | | | | | |
| Comparative | P | 0.035 | — | 0.000 | 525 | — | — | 0.98 | 1.32 | 1.58 | 13.8 |
| example 102 | | | | | | | | | | | |

TABLE 3

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} | | | | | | | | | | | |
| | Fe | | Co | | A | | | | | Xₓ = X1ₓ₁X2ₓ₂X3ₓ₃ | | |
| | (1 − (α + β)) × | | α × | | | β × | | M | | (x = x1 + x2 + x3) | | |
| | (1 − (m + x + d)) | 1 − α − β | (1 − (m + X + d)) | α | A | (1 − (m + x + d)) | β | M | m | X1 | x1 | X2 |
| Example 10 | 0.540 | 0.643 | 0.294 | 0.350 | Cu | 0.006 | 0.007 | Nb | 0.075 | B | 0.050 | P |
| Comparative | 0.540 | 0.643 | 0.294 | 0.350 | Cu | 0.006 | 0.007 | Nb | 0.075 | B | 0.050 | P |
| example 6 | | | | | | | | | | | | |
| Example 11 | 0.598 | 0.787 | 0.152 | 0.200 | Cu | 0.010 | 0.013 | Nb | 0.030 | B | 0.080 | Si |
| Comparative | 0.598 | 0.787 | 0.152 | 0.200 | Cu | 0.010 | 0.013 | Nb | 0.030 | B | 0.080 | Si |
| example 7 | | | | | | | | | | | | |
| Example 12 | 0.509 | 0.592 | 0.344 | 0.400 | Cu | 0.007 | 0.008 | — | 0.000 | B | 0.080 | P |
| Comparative | 0.509 | 0.592 | 0.344 | 0.400 | Cu | 0.007 | 0.008 | — | 0.000 | B | 0.080 | P |
| example 8 | | | | | | | | | | | | |
| Example 13 | 0.549 | 0.650 | 0.296 | 0.350 | — | 0.000 | 0.000 | Nb | 0.075 | B | 0.040 | P |
| Example 14 | 0.546 | 0.650 | 0.294 | 0.350 | — | 0.000 | 0.000 | Nb | 0.075 | B | 0.040 | P |
| Example 14a | 0.672 | 0.800 | 0.168 | 0.200 | — | 0.000 | 0.000 | Nb | 0.075 | B | 0.040 | P |
| Example 14b | 0.756 | 0.900 | 0.084 | 0.100 | — | 0.000 | 0.000 | Nb | 0.075 | B | 0.040 | P |
| Example 14c | 0.798 | 0.950 | 0.042 | 0.050 | — | 0.000 | 0.000 | Nb | 0.075 | B | 0.040 | P |
| Example 14d | 0.798 | 0.950 | 0.042 | 0.050 | — | 0.000 | 0.000 | Nb | 0.075 | B | 0.040 | P |
| Example 14e | 0.798 | 0.950 | 0.042 | 0.050 | — | 0.000 | 0.000 | Nb | 0.075 | B | 0.040 | P |
| Example 15 | 0.533 | 0.650 | 0.287 | 0.350 | — | 0.000 | 0.000 | Nb | 0.075 | B | 0.040 | P |
| Example 17 | 0.546 | 0.650 | 0.294 | 0.350 | — | 0.000 | 0.000 | Nb | 0.075 | B | 0.040 | P |
| Example 18 | 0.533 | 0.650 | 0.294 | 0.350 | — | 0.000 | 0.000 | Nb | 0.075 | B | 0.040 | P |
| Example 16 | 0.520 | 0.650 | 0.294 | 0.350 | — | 0.000 | 0.000 | Nb | 0.075 | B | 0.040 | P |
| Example 19 | 0.672 | 0.800 | 0.168 | 0.200 | — | 0.000 | 0.000 | Ta | 0.080 | C | 0.060 | P |
| Example 20 | 0.796 | 0.900 | 0.088 | 0.100 | — | 0.000 | 0.000 | Zr | 0.110 | — | 0.000 | — |
| Example 21 | 0.792 | 0.900 | 0.088 | 0.100 | — | 0.000 | 0.000 | Zr | 0.110 | — | 0.000 | — |
| Example 22 | 0.774 | 0.900 | 0.086 | 0.100 | — | 0.000 | 0.000 | Zr | 0.110 | — | 0.000 | — |
| Example 23 | 0.797 | 0.900 | 0.088 | 0.100 | — | 0.000 | 0.000 | Zr | 0.110 | — | 0.000 | — |
| Example 24 | 0.792 | 0.900 | 0.088 | 0.100 | — | 0.000 | 0.000 | Zr | 0.110 | — | 0.000 | — |
| Example 25 | 0.774 | 0.900 | 0.088 | 0.100 | — | 0.000 | 0.000 | Zr | 0.110 | — | 0.000 | — |
| Comparative | 0.798 | 0.950 | 0.042 | 0.050 | — | 0.000 | 0.000 | Nb | 0.075 | B | 0.040 | P |
| example 103 | | | | | | | | | | | | |
| Comparative | 0.546 | 0.650 | 0.294 | 0.350 | — | 0.000 | 0.000 | Nb | 0.075 | B | 0.040 | P |
| example 104 | | | | | | | | | | | | |
| Comparative | 0.792 | 0.900 | 0.088 | 0.100 | — | 0.000 | 0.000 | Zr | 0.110 | — | 0.000 | — |
| example 105 | | | | | | | | | | | | |
| Comparative | 0.792 | 0.900 | 0.088 | 0.100 | — | 0.000 | 0.000 | Zr | 0.110 | — | 0.000 | — |
| example 106 | | | | | | | | | | | | |
| Comparative | 0.672 | 0.800 | 0.168 | 0.200 | — | 0.000 | 0.000 | Ta | 0.080 | C | 0.060 | P |
| example 107 | | | | | | | | | | | | |

| | | | | | | Heat | | | | | | |
|---|---|---|---|---|---|---|---|---|---|---|---|---|
| | | | | | | treatment | Heat press | | | | | |
| | Soft magnetic alloy composition | | | | | condition | treatment | | | | | |
| | (Fe_{1-(α+β)}Co_{α}A_{β})_{1-(m+x+d)}MₘXₓD_{d} | | | | | Heat | condition | | | {R(Co1) + | Magnetic | |
| | Xₓ = X1ₓ₁X2ₓ₂X3ₓ₃ | | | | | treatment | Press | Press | | R(Co3)}/ | properties | |
| | (x = x1 + x2 + x3) | | | D | | Temp. | Temp. | pressure | R(Co4)/ | {R(Fe1) + | Bs | Hc |
| | x2 | X3 | x3 | D | d | ° C. | ° C. | MPa | R(Fe4) | R(Fe3)} | (T) | (A/m) |
| Example 10 | 0.035 | — | 0.000 | — | 0.000 | 525 | 400 | 0.5 | 0.84 | 2.32 | 1.72 | 3.5 |
| Comparative | 0.035 | — | 0.000 | — | 0.000 | 525 | — | — | 0.97 | 1.11 | 1.70 | 13.1 |
| example 6 | | | | | | | | | | | | |
| Example 11 | 0.130 | — | 0.000 | — | 0.000 | 525 | 400 | 0.5 | 0.80 | 2.45 | 1.50 | 2.8 |
| Comparative | 0.130 | — | 0.000 | — | 0.000 | 525 | — | — | 0.98 | 1.06 | 1.49 | 12.9 |
| example 7 | | | | | | | | | | | | |
| Example 12 | 0.040 | Si | 0.020 | — | 0.000 | 425 | 400 | 0.5 | 0.84 | 2.01 | 1.82 | 6.6 |
| Comparative | 0.040 | Si | 0.020 | — | 0.000 | 425 | — | — | 0.93 | 1.40 | 1.79 | 15.0 |
| example 8 | | | | | | | | | | | | |
| Example 13 | 0.035 | — | 0.000 | Ni | 0.005 | 525 | 400 | 0.5 | 0.76 | 2.80 | 1.74 | 3.3 |
| Example 14 | 0.035 | — | 0.000 | Ni | 0.010 | 525 | 400 | 0.5 | 0.74 | 2.90 | 1.78 | 1.8 |
| Example 14a | 0.035 | — | 0.000 | Ni | 0.010 | 525 | 400 | 0.5 | 0.71 | 3.41 | 1.71 | 1.6 |
| Example 14b | 0.035 | — | 0.000 | Ni | 0.010 | 525 | 400 | 0.5 | 0.65 | 3.92 | 1.69 | 1.4 |
| Example 14c | 0.035 | — | 0.000 | Ni | 0.010 | 525 | 400 | 0.5 | 0.60 | 4.56 | 1.66 | 1.1 |
| Example 14d | 0.035 | — | 0.000 | Ni | 0.010 | 525 | 400 | 1.0 | 0.54 | 5.71 | 1.61 | 1.4 |
| Example 14e | 0.035 | — | 0.000 | Ni | 0.010 | 525 | 425 | 1.0 | 0.49 | 6.00 | 1.55 | 1.1 |
| Example 15 | 0.035 | — | 0.000 | Ni | 0.030 | 525 | 400 | 0.5 | 0.81 | 2.26 | 1.72 | 1.9 |
| Example 17 | 0.035 | — | 0.000 | Mn | 0.010 | 525 | 400 | 0.5 | 0.74 | 2.79 | 1.76 | 2.5 |
| Example 18 | 0.035 | — | 0.000 | Mn | 0.030 | 525 | 400 | 0.5 | 0.79 | 2.30 | 1.70 | 2.2 |
| Example 16 | 0.035 | — | 0.000 | Mn | 0.050 | 525 | 400 | 0.5 | 0.77 | 2.58 | 1.74 | 3.6 |
| Example 19 | 0.020 | — | 0.000 | — | 0.000 | 525 | 400 | 0.5 | 0.77 | 2.50 | 1.80 | 3.3 |
| Example 20 | 0.000 | — | 0.000 | Ni | 0.005 | 475 | 400 | 0.5 | 0.75 | 2.77 | 1.72 | 4.0 |
| Example 21 | 0.000 | — | 0.000 | Ni | 0.010 | 475 | 400 | 0.5 | 0.75 | 2.85 | 1.79 | 2.0 |
| Example 22 | 0.000 | — | 0.000 | Ni | 0.030 | 475 | 400 | 0.5 | 0.78 | 2.33 | 1.71 | 4.5 |
| Example 23 | 0.000 | — | 0.000 | Mn | 0.005 | 475 | 400 | 0.5 | 0.74 | 2.66 | 1.80 | 1.9 |
| Example 24 | 0.000 | — | 0.000 | Mn | 0.010 | 475 | 400 | 0.5 | 0.76 | 2.83 | 1.76 | 2.2 |
| Example 25 | 0.000 | — | 0.000 | Mn | 0.030 | 475 | 400 | 0.5 | 0.80 | 2.55 | 1.73 | 2.8 |
| Comparative | 0.035 | — | 0.000 | Ni | 0.010 | 525 | — | — | 0.92 | 1.50 | 1.60 | 13.8 |
| example 103 | | | | | | | | | | | | |
| Comparative | 0.035 | — | 0.000 | Mn | 0.010 | 525 | — | — | 1.03 | 1.28 | 1.75 | 14.1 |
| example 104 | | | | | | | | | | | | |
| Comparative | 0.000 | — | 0.000 | Ni | 0.010 | 475 | — | — | 1.09 | 1.32 | 1.78 | 12.8 |
| example 105 | | | | | | | | | | | | |
| Comparative | 0.000 | — | 0.000 | Mn | 0.010 | 475 | — | — | 1.03 | 1.29 | 1.74 | 13.3 |
| example 106 | | | | | | | | | | | | |
| Comparative | 0.020 | — | 0.000 | — | 0.000 | 525 | — | — | 1.05 | 1.33 | 1.77 | 13.4 |
| example 107 | | | | | | | | | | | | |

TABLE 4A

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (β = 0, d = 0) | | | | | | | | | | | |
| | Fe | | Co | | M = M1ₘ₁M2ₘ₂ | | | | Xₓ = X1ₓ₁X2ₓ₂ | | | |
| | (1 − (α + β)) × | | α × | | (m = m1 + m2) | | | | (x = x1 + x2) | | | |
| | (1 − (m + x + d)) | 1 − (α + β) | (1 − (m + X + d)) | α | M1 | m1 | M2 | m2 | X1 | x1 | X2 | x2 |
| Example 26 | 0.652 | 0.800 | 0.163 | 0.200 | Nb | 0.020 | — | — | B | 0.130 | P | 0.035 |
| Example 27 | 0.652 | 0.800 | 0.163 | 0.200 | Nb | 0.040 | — | — | R | 0.110 | P | 0.035 |
| Example 28 | 0.672 | 0.800 | 0.168 | 0.200 | Nb | 0.055 | — | — | B | 0.070 | P | 0.035 |
| Example 7 | 0.672 | 0.800 | 0.168 | 0.200 | Nb | 0.075 | — | — | B | 0.050 | P | 0.035 |
| Example 29 | 0.668 | 0.800 | 0.167 | 0.200 | Nb | 0.075 | — | — | B | 0.090 | — | 0.000 |
| Example 30 | 0.672 | 0.800 | 0.168 | 0.200 | Nb | 0.090 | — | — | B | 0.035 | P | 0.035 |
| Example 31 | 0.672 | 0.800 | 0.168 | 0.200 | Nb | 0.020 | Zr | 0.055 | B | 0.050 | P | 0.035 |
| Example 32 | 0.672 | 0.800 | 0.168 | 0.200 | Nb | 0.040 | Zr | 0.035 | B | 0.050 | P | 0.035 |
| Example 33 | 0.672 | 0.800 | 0.168 | 0.200 | Nb | 0.055 | Zr | 0.020 | B | 0.050 | P | 0.035 |
| Example 34 | 0.652 | 0.800 | 0.163 | 0.200 | Zr | 0.020 | — | — | B | 0.130 | P | 0.035 |
| Example 35 | 0.652 | 0.800 | 0.163 | 0.200 | Zr | 0.040 | — | — | B | 0.110 | P | 0.035 |
| Example 36 | 0.672 | 0.800 | 0.168 | 0.200 | Zr | 0.055 | — | — | B | 0.070 | P | 0.035 |
| Example 37 | 0.672 | 0.800 | 0.168 | 0.200 | Zr | 0.075 | — | — | B | 0.050 | P | 0.035 |
| Example 38 | 0.672 | 0.800 | 0.168 | 0.200 | Zr | 0.090 | — | — | B | 0.035 | P | 0.035 |
| Example 39 | 0.652 | 0.800 | 0.163 | 0.200 | Ti | 0.020 | — | — | B | 0.130 | P | 0.035 |
| Example 40 | 0.652 | 0.800 | 0.163 | 0.200 | Ti | 0.040 | — | — | B | 0.110 | P | 0.035 |
| Example 41 | 0.672 | 0.800 | 0.168 | 0.200 | Ti | 0.055 | — | — | B | 0.070 | P | 0.035 |
| Example 42 | 0.672 | 0.800 | 0.168 | 0.200 | Ti | 0.075 | — | — | B | 0.050 | P | 0.035 |
| Example 43 | 0.672 | 0.800 | 0.168 | 0.200 | Ti | 0.090 | — | — | B | 0.035 | P | 0.035 |
| Comparative | 0.652 | 0.800 | 0.163 | 0.200 | Nb | 0.020 | — | — | B | 0.130 | P | 0.035 |
| example 108 | | | | | | | | | | | | |
| Comparative | 0.672 | 0.800 | 0.168 | 0.200 | Nb | 0.090 | — | — | B | 0.035 | P | 0.035 |
| example 109 | | | | | | | | | | | | |
| Comparative | 0.672 | 0.800 | 0.168 | 0.200 | Zr | 0.075 | — | — | B | 0.050 | P | 0.035 |
| example 110 | | | | | | | | | | | | |
| Comparative | 0.672 | 0.800 | 0.168 | 0.200 | Ti | 0.075 | — | — | B | 0.050 | P | 0.035 |
| example 111 | | | | | | | | | | | | |

| | Heat press | | | | | |
|---|---|---|---|---|---|---|
| | treatment condition | | | {R(Co1) + | Magnetic | |
| | Press | Press | | R(Co3)}/ | properties | |
| | Temp. | pressure | R(Co4)/ | {R(Fe1) + | Bs | Hc |
| | ° C. | MPa | R(Fe4) | R(Fe3)} | (T) | (A/m) |
| Example 26 | 400 | 0.5 | 0.88 | 1.64 | 1.73 | 7.8 |
| Example 27 | 400 | 0.5 | 0.85 | 1.66 | 1.72 | 4.5 |
| Example 28 | 400 | 0.5 | 0.84 | 1.70 | 1.70 | 2.5 |
| Example 7 | 400 | 0.5 | 0.79 | 1.98 | 1.68 | 3.0 |
| Example 29 | 400 | 0.5 | 0.78 | 2.00 | 1.66 | 2.9 |
| Example 30 | 400 | 0.5 | 0.76 | 2.22 | 1.63 | 4.1 |
| Example 31 | 400 | 0.5 | 0.83 | 2.10 | 1.70 | 7.2 |
| Example 32 | 400 | 0.5 | 0.79 | 2.04 | 1.67 | 4.7 |
| Example 33 | 400 | 0.5 | 0.77 | 1.98 | 1.65 | 3.1 |
| Example 34 | 400 | 0.5 | 0.89 | 1.70 | 1.68 | 8.2 |
| Example 35 | 400 | 0.5 | 0.86 | 1.82 | 1.67 | 4.0 |
| Example 36 | 400 | 0.5 | 0.80 | 1.90 | 1.67 | 2.1 |
| Example 37 | 400 | 0.5 | 0.76 | 2.05 | 1.64 | 2.8 |
| Example 38 | 400 | 0.5 | 0.73 | 2.24 | 1.61 | 3.6 |
| Example 39 | 400 | 0.5 | 0.87 | 1.60 | 1.75 | 9.5 |
| Example 40 | 400 | 0.5 | 0.84 | 1.66 | 1.73 | 5.5 |
| Example 41 | 400 | 0.5 | 0.79 | 1.75 | 1.69 | 4.2 |
| Example 42 | 400 | 0.5 | 0.79 | 1.88 | 1.66 | 3.9 |
| Example 43 | 400 | 0.5 | 0.77 | 2.10 | 1.66 | 5.0 |
| Comparative | — | — | 1.05 | 1.22 | 1.72 | 13.8 |
| example 108 | | | | | | |
| Comparative | — | — | 1.00 | 1.15 | 1.62 | 13.3 |
| example 109 | | | | | | |
| Comparative | — | — | 1.01 | 1.32 | 1.61 | 12.9 |
| example 110 | | | | | | |
| Comparative | — | — | 1.03 | 1.33 | 1.65 | 13.4 |
| example 111 | | | | | | |

TABLE 4B

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (β = 0, d = 0) | | | | | | | | | | | |
| | Fe | | Co | | M = M1ₘ₁M2ₘ₂ | | | | Xₓ = X1ₓ₁X2ₓ₂ | | | |
| | (1 − (α + β)) × | | α × | | (m = m1 + m2) | | | | (x = x1 + x2) | | | |
| | (1 − (m + x + d)) | 1 − (α + β) | (1 − (m + X + d)) | α | M1 | m1 | M2 | m2 | X1 | x1 | X2 | x2 |
| Example 44 | 0.652 | 0.800 | 0.163 | 0.200 | V | 0.020 | — | — | B | 0.130 | P | 0.035 |
| Example 45 | 0.652 | 0.800 | 0.163 | 0.200 | V | 0.040 | — | — | B | 0.110 | P | 0.035 |
| Example 46 | 0.672 | 0.800 | 0.168 | 0.200 | V | 0.055 | — | — | B | 0.070 | P | 0.035 |
| Example 47 | 0.672 | 0.800 | 0.168 | 0.200 | V | 0.075 | — | — | B | 0.050 | P | 0.035 |
| Example 48 | 0.672 | 0.800 | 0.168 | 0.200 | V | 0.090 | — | — | B | 0.035 | P | 0.035 |
| Example 49 | 0.652 | 0.800 | 0.163 | 0.200 | Cr | 0.020 | — | — | B | 0.130 | P | 0.035 |
| Example 50 | 0.652 | 0.800 | 0.163 | 0.200 | Cr | 0.040 | — | — | B | 0.110 | P | 0.035 |
| Example 51 | 0.672 | 0.800 | 0.168 | 0.200 | Hf | 0.055 | — | — | B | 0.070 | P | 0.035 |
| Example 52 | 0.672 | 0.800 | 0.168 | 0.200 | Hf | 0.075 | — | — | B | 0.050 | P | 0.035 |
| Example 53 | 0.672 | 0.800 | 0.168 | 0.200 | Hf | 0.090 | — | — | B | 0.035 | P | 0.035 |
| Example 54 | 0.652 | 0.800 | 0.163 | 0.200 | Ta | 0.020 | — | — | B | 0.130 | P | 0.035 |
| Example 55 | 0.652 | 0.800 | 0.163 | 0.200 | Ta | 0.040 | — | — | B | 0.110 | P | 0.035 |
| Example 56 | 0.672 | 0.800 | 0.168 | 0.200 | Ta | 0.075 | — | — | B | 0.050 | P | 0.035 |
| Example 57 | 0.672 | 0.800 | 0.168 | 0.200 | Ta | 0.055 | — | — | B | 0.070 | P | 0.035 |
| Example 58 | 0.672 | 0.800 | 0.168 | 0.200 | Ta | 0.090 | — | — | B | 0.035 | P | 0.035 |
| Example 59 | 0.652 | 0.800 | 0.163 | 0.200 | Mo | 0.020 | — | — | B | 0.130 | P | 0.035 |
| Example 60 | 0.672 | 0.800 | 0.168 | 0.200 | Mo | 0.035 | — | — | B | 0.090 | P | 0.035 |
| Example 61 | 0.652 | 0.800 | 0.163 | 0.200 | W | 0.020 | — | — | B | 0.130 | P | 0.035 |
| Example 62 | 0.672 | 0.800 | 0.168 | 0.200 | W | 0.035 | — | — | B | 0.090 | P | 0.035 |
| Comparative | 0.672 | 0.800 | 0.168 | 0.200 | V | 0.075 | — | — | B | 0.050 | P | 0.035 |
| example 112 | | | | | | | | | | | | |
| Comparative | 0.652 | 0.800 | 0.163 | 0.200 | Cr | 0.040 | — | — | B | 0.110 | P | 0.035 |
| example 113 | | | | | | | | | | | | |
| Comparative | 0.672 | 0.800 | 0.168 | 0.200 | Hf | 0.075 | — | — | B | 0.050 | P | 0.035 |
| example 114 | | | | | | | | | | | | |
| Comparative | 0.672 | 0.800 | 0.168 | 0.200 | Ta | 0.075 | — | — | B | 0.050 | P | 0.035 |
| example 115 | | | | | | | | | | | | |
| Comparative | 0.672 | 0.800 | 0.168 | 0.200 | Mo | 0.035 | — | — | B | 0.090 | P | 0.035 |
| example 116 | | | | | | | | | | | | |
| Comparative | 0.672 | 0.800 | 0.168 | 0.200 | W | 0.035 | — | — | B | 0.090 | P | 0.035 |
| example 117 | | | | | | | | | | | | |

| | Heat press | | | | | |
|---|---|---|---|---|---|---|
| | treatment condition | | | {R(Co1) + | Magnetic | |
| | Press | Press | | R(Co3)}/ | properties | |
| | Temp. | pressure | R(Co4)/ | {R(Fe1) + | Bs | Hc |
| | ° C. | MPa | R(Fe4) | R(Fe3)} | (T) | (A/m) |
| Example 44 | 400 | 0.5 | 0.83 | 1.66 | 1.72 | 8.6 |
| Example 45 | 400 | 0.5 | 0.80 | 1.67 | 1.67 | 5.5 |
| Example 46 | 400 | 0.5 | 0.77 | 1.80 | 1.66 | 3.6 |
| Example 47 | 400 | 0.5 | 0.77 | 1.98 | 1.62 | 2.4 |
| Example 48 | 400 | 0.5 | 0.80 | 2.00 | 1.60 | 3.8 |
| Example 49 | 400 | 0.5 | 0.86 | 1.70 | 1.69 | 9.0 |
| Example 50 | 400 | 0.5 | 0.80 | 1.98 | 1.66 | 5.5 |
| Example 51 | 400 | 0.5 | 0.78 | 2.12 | 1.71 | 3.0 |
| Example 52 | 400 | 0.5 | 0.75 | 2.20 | 1.64 | 2.2 |
| Example 53 | 400 | 0.5 | 0.74 | 2.59 | 1.62 | 3.9 |
| Example 54 | 400 | 0.5 | 0.80 | 1.90 | 1.74 | 5.0 |
| Example 55 | 400 | 0.5 | 0.79 | 2.25 | 1.73 | 4.1 |
| Example 56 | 400 | 0.5 | 0.75 | 2.30 | 1.69 | 3.1 |
| Example 57 | 400 | 0.5 | 0.79 | 2.19 | 1.71 | 2.7 |
| Example 58 | 400 | 0.5 | 0.73 | 2.45 | 1.64 | 4.0 |
| Example 59 | 400 | 0.5 | 0.88 | 1.66 | 1.72 | 7.4 |
| Example 60 | 400 | 0.5 | 0.83 | 1.74 | 1.70 | 5.5 |
| Example 61 | 400 | 0.5 | 0.86 | 1.65 | 1.71 | 8.9 |
| Example 62 | 400 | 0.5 | 0.84 | 1.80 | 1.63 | 4.4 |
| Comparative | — | — | 0.97 | 1.45 | 1.61 | 14.1 |
| example 112 | | | | | | |
| Comparative | — | — | 0.93 | 1.20 | 1.65 | 13.1 |
| example 113 | | | | | | |
| Comparative | — | — | 1.02 | 1.33 | 1.61 | 13.3 |
| example 114 | | | | | | |
| Comparative | — | — | 1.04 | 1.45 | 1.68 | 15.1 |
| example 115 | | | | | | |
| Comparative | — | — | 1.01 | 1.34 | 1.68 | 14.6 |
| example 116 | | | | | | |
| Comparative | — | — | 0.94 | 1.43 | 1.61 | 13.0 |
| example 117 | | | | | | |

TABLE 5

| | Soft magnetic alloy composition | | | | | | | | | | |
|---|---|---|---|---|---|---|---|---|---|---|---|
| | (Fe_{1-(α+β)}Co_{α}A_{β})_{1-(m+x+d)}MₘXₓD_{d} | | | | | | | | | | |
| | Fe | | Co | | A | | | | | Xₓ = X1ₓ₁X2ₓ₂ | |
| | (1 − (α + β)) × | | α × | | | β × | | M | | (x = x1 + x2) | |
| | (1 − (m + x + d)) | 1 − (α + β) | (1 − (m + X + d)) | α | A | (1 − (m + x + d)) | β | M | m | X1 | x1 |
| Example 7 | 0.672 | 0.800 | 0.168 | 0.200 | — | 0.000 | 0.000 | Nb | 0.075 | B | 0.050 |
| Example 63 | 0.664 | 0.790 | 0.168 | 0.200 | Cu | 0.008 | 0.010 | Nb | 0.075 | B | 0.050 |
| Example 64 | 0.664 | 0.790 | 0.168 | 0.200 | Al | 0.008 | 0.010 | Nb | 0.075 | B | 0.050 |
| Example 65 | 0.655 | 0.780 | 0.168 | 0.200 | Zn | 0.017 | 0.020 | Nb | 0.075 | B | 0.050 |
| Example 66 | 0.668 | 0.795 | 0.168 | 0.200 | Mg | 0.004 | 0.005 | Nb | 0.075 | B | 0.050 |
| Example 67 | 0.665 | 0.792 | 0.168 | 0.200 | Ca | 0.007 | 0.008 | Nb | 0.075 | B | 0.050 |
| Example 68 | 0.671 | 0.799 | 0.168 | 0.200 | O | 0.001 | 0.001 | Nb | 0.075 | B | 0.050 |
| Example 69 | 0.671 | 0.799 | 0.168 | 0.200 | S | 0.001 | 0.001 | Nb | 0.075 | B | 0.050 |
| Example 63 | 0.664 | 0.790 | 0.168 | 0.200 | Cu | 0.008 | 0.010 | Nb | 0.075 | B | 0.050 |
| Example 70 | 0.656 | 0.790 | 0.164 | 0.200 | Cu | 0.008 | 0.010 | Nb | 0.075 | B | 0.050 |
| Example 71 | 0.648 | 0.790 | 0.160 | 0.200 | Cu | 0.008 | 0.010 | Nb | 0.075 | B | 0.050 |
| Example 72 | 0.692 | 0.800 | 0.173 | 0.200 | — | 0.000 | 0.000 | Nb | 0.075 | B | 0.040 |
| Example 7 | 0.672 | 0.800 | 0.168 | 0.200 | — | 0.000 | 0.000 | Nb | 0.075 | B | 0.050 |
| Example 73 | 0.656 | 0.800 | 0.164 | 0.200 | — | 0.000 | 0.000 | Nb | 0.075 | B | 0.070 |
| Example 74 | 0.640 | 0.800 | 0.160 | 0.200 | — | 0.000 | 0.000 | Nb | 0.075 | B | 0.090 |
| Example 75 | 0.624 | 0.800 | 0.156 | 0.200 | — | 0.000 | 0.000 | Nb | 0.075 | B | 0.110 |
| Comparative | 0.664 | 0.790 | 0.168 | 0.200 | Al | 0.008 | 0.010 | Nb | 0.075 | B | 0.050 |
| example 118 | | | | | | | | | | | |
| Comparative | 0.655 | 0.780 | 0.168 | 0.200 | Zn | 0.017 | 0.020 | Nb | 0.075 | B | 0.050 |
| example 119 | | | | | | | | | | | |
| Comparative | 0.668 | 0.795 | 0.168 | 0.200 | Mg | 0.004 | 0.005 | Nb | 0.075 | B | 0.050 |
| example 120 | | | | | | | | | | | |
| Comparative | 0.665 | 0.792 | 0.168 | 0.200 | Ca | 0.007 | 0.008 | Nb | 0.075 | B | 0.050 |
| example 121 | | | | | | | | | | | |
| Comparative | 0.671 | 0.799 | 0.168 | 0.200 | O | 0.001 | 0.001 | Nb | 0.075 | B | 0.050 |
| example 122 | | | | | | | | | | | |
| Comparative | 0.671 | 0.799 | 0.168 | 0.200 | S | 0.001 | 0.001 | Nb | 0.075 | B | 0.050 |
| example 123 | | | | | | | | | | | |

| | Soft magnetic alloy composition | | | | Heat press | | | | | |
|---|---|---|---|---|---|---|---|---|---|---|
| | (Fe_{1-(α+β)}Co_{α}A_{β})_{1-(m+x+d)}MₘXₓD_{d} | | | | treatment condition | | | {R(Co1) + | Magnetic | |
| | Xₓ = X1ₓ₁X2ₓ₂ | | | | Press | Press | | R(Co3)}/ | properties | |
| | (x = x1 + x2) | | D | | Temp. | pressure | R(Co4)/ | {R(Fe1) + | Bs | Hc |
| | X2 | x2 | D | d | ° C. | MPa | R(Fe4) | R(Fe3)} | (T) | (A/m) |
| Example 7 | P | 0.035 | — | 0.000 | 400 | 0.5 | 0.79 | 1.98 | 1.68 | 3.0 |
| Example 63 | P | 0.035 | — | 0.000 | 400 | 0.5 | 0.76 | 2.08 | 1.71 | 2.5 |
| Example 64 | P | 0.035 | — | 0.000 | 400 | 0.5 | 0.76 | 1.92 | 1.66 | 4.1 |
| Example 65 | P | 0.035 | — | 0.000 | 400 | 0.5 | 0.75 | 1.99 | 1.65 | 3.3 |
| Example 66 | P | 0.035 | — | 0.000 | 400 | 0.5 | 0.78 | 1.89 | 1.66 | 3.1 |
| Example 67 | P | 0.035 | — | 0.000 | 400 | 0.5 | 0.77 | 1.95 | 1.62 | 3.6 |
| Example 68 | P | 0.035 | — | 0.000 | 400 | 0.5 | 0.76 | 1.94 | 1.68 | 3.0 |
| Example 69 | P | 0.035 | — | 0.000 | 400 | 0.5 | 0.80 | 1.99 | 1.68 | 3.0 |
| Example 63 | P | 0.035 | — | 0.000 | 400 | 0.5 | 0.76 | 2.08 | 1.71 | 2.5 |
| Example 70 | P | 0.035 | Ni | 0.010 | 400 | 0.5 | 0.74 | 2.20 | 1.75 | 2.1 |
| Example 71 | P | 0.035 | Mn | 0.020 | 400 | 0.5 | 0.74 | 2.29 | 1.72 | 2.2 |
| Example 72 | P | 0.020 | — | 0.000 | 400 | 0.5 | 0.76 | 2.11 | 1.77 | 4.5 |
| Example 7 | P | 0.035 | — | 0.000 | 400 | 0.5 | 0.79 | 1.98 | 1.68 | 3.0 |
| Example 73 | P | 0.035 | — | 0.000 | 400 | 0.5 | 0.80 | 1.95 | 1.66 | 3.2 |
| Example 74 | P | 0.035 | — | 0.000 | 400 | 0.5 | 0.83 | 1.91 | 1.63 | 3.0 |
| Example 75 | P | 0.035 | — | 0.000 | 400 | 0.5 | 0.85 | 1.88 | 1.61 | 2.3 |
| Comparative | P | 0.035 | — | 0.000 | — | — | 0.99 | 1.22 | 1.65 | 13.3 |
| example 118 | | | | | | | | | | |
| Comparative | P | 0.035 | — | 0.000 | — | — | 1.04 | 1.32 | 1.62 | 14.1 |
| example 119 | | | | | | | | | | |
| Comparative | P | 0.035 | — | 0.000 | — | — | 0.93 | 1.27 | 1.62 | 13.8 |
| example 120 | | | | | | | | | | |
| Comparative | P | 0.035 | — | 0.000 | — | — | 0.96 | 1.34 | 1.61 | 13.2 |
| example 121 | | | | | | | | | | |
| Comparative | P | 0.035 | — | 0.000 | — | — | 1.06 | 1.18 | 1.67 | 15.1 |
| example 122 | | | | | | | | | | |
| Comparative | P | 0.035 | — | 0.000 | — | — | 0.95 | 1.41 | 1.67 | 14.7 |
| example 123 | | | | | | | | | | |

TABLE 6A

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (β = 0, d = 0) | | | | | | | | | | | |
| | Fe | | Co | | | | Xₓ = X1ₓ₁X2ₓ₂X3ₓ₃ | | | | | |
| | (1 − (α + β)) × | | α × | | M | | (x = x1 + x2 + x3) | | | | | |
| | (1 − (m + x + d)) | 1 − (α + β) | (1 − (m + X + d)) | α | M | m | X1 | x1 | X2 | x2 | X3 | x3 |
| Example 101 | 0.593 | 0.750 | 0.198 | 0.250 | Nb | 0.060 | B | 0.080 | P | 0.070 | — | 0.000 |
| Example 102 | 0.593 | 0.750 | 0.198 | 0.250 | Nb | 0.060 | B | 0.120 | P | 0.030 | — | 0.000 |
| Example 103 | 0.589 | 0.750 | 0.196 | 0.250 | Nb | 0.060 | B | 0.145 | P | 0.010 | — | 0.000 |
| Example 104 | 0.593 | 0.750 | 0.198 | 0.250 | Nb | 0.060 | B | 0.080 | Si | 0.070 | — | 0.000 |
| Example 105 | 0.593 | 0.750 | 0.198 | 0.250 | Nb | 0.060 | B | 0.120 | Si | 0.030 | — | 0.000 |
| Example 106 | 0.593 | 0.750 | 0.198 | 0.250 | Nb | 0.060 | B | 0.145 | Si | 0.005 | — | 0.000 |
| Example 107 | 0.593 | 0.750 | 0.198 | 0.250 | Nb | 0.060 | B | 0.100 | C | 0.050 | — | 0.000 |
| Example 108 | 0.608 | 0.750 | 0.203 | 0.250 | Nb | 0.060 | B | 0.120 | C | 0.010 | — | 0.000 |
| Example 109 | 0.608 | 0.750 | 0.203 | 0.250 | Nb | 0.060 | B | 0.125 | C | 0.005 | — | 0.000 |
| Example 110 | 0.578 | 0.750 | 0.193 | 0.250 | Nb | 0.080 | B | 0.130 | P | 0.010 | Si | 0.010 |
| Example 111 | 0.563 | 0.750 | 0.188 | 0.250 | Nb | 0.080 | B | 0.070 | P | 0.050 | Si | 0.050 |
| Example 112 | 0.600 | 0.750 | 0.200 | 0.250 | Nb | 0.050 | B | 0.130 | P | 0.010 | Si | 0.010 |
| Example 113 | 0.585 | 0.750 | 0.195 | 0.250 | Nb | 0.050 | B | 0.070 | P | 0.050 | Si | 0.050 |
| Example 114 | 0.578 | 0.750 | 0.193 | 0.250 | Nb | 0.080 | B | 0.130 | P | 0.010 | C | 0.010 |
| Example 115 | 0.563 | 0.750 | 0.188 | 0.250 | Nb | 0.080 | B | 0.070 | P | 0.050 | C | 0.050 |
| Example 116 | 0.600 | 0.750 | 0.200 | 0.250 | Nb | 0.050 | B | 0.130 | P | 0.010 | C | 0.010 |
| Example 117 | 0.585 | 0.750 | 0.195 | 0.250 | Nb | 0.050 | B | 0.070 | P | 0.050 | C | 0.050 |
| Example 118 | 0.564 | 0.700 | 0.242 | 0.300 | Nb | 0.030 | B | 0.090 | P | 0.070 | Si | 0.005 |
| Example 119 | 0.560 | 0.700 | 0.240 | 0.300 | Nb | 0.030 | B | 0.110 | P | 0.030 | Si | 0.030 |
| Example 120 | 0.560 | 0.700 | 0.240 | 0.300 | Nb | 0.030 | B | 0.110 | P | 0.010 | Si | 0.050 |
| Example 121 | 0.567 | 0.700 | 0.243 | 0.300 | Nb | 0.020 | B | 0.110 | P | 0.030 | Si | 0.030 |
| Example 122 | 0.567 | 0.700 | 0.243 | 0.300 | Nb | 0.010 | B | 0.110 | P | 0.040 | Si | 0.030 |
| Example 123 | 0.490 | 0.700 | 0.210 | 0.300 | Nb | 0.030 | B | 0.230 | — | 0.000 | — | 0.000 |
| Comparative | 0.564 | 0.700 | 0.242 | 0.300 | Nb | 0.030 | B | 0.090 | P | 0.070 | Si | 0.005 |
| example 124 | | | | | | | | | | | | |
| Comparative | 0.600 | 0.750 | 0.200 | 0.250 | Nb | 0.050 | B | 0.130 | P | 0.010 | C | 0.010 |
| example 125 | | | | | | | | | | | | |

| | Heat | | | | | | |
|---|---|---|---|---|---|---|---|
| | treatment | Heat press | | | | | |
| | conditin | treatmet | | | | | |
| | Heat | condition | | | {R(Co1) + | Magnetic | |
| | treatment | Press | Press | | R(Co3)}/ | properties | |
| | Temp. | Temp. | pressure | R(Co4)/ | {R(Fe1) + | Bs | Hc |
| | ° C. | ° C. | MPa | R(Fe4) | R(Fe3)} | (T) | (A/m) |
| Example 101 | 525 | 400 | 0.5 | 0.88 | 2.09 | 1.63 | 4.2 |
| Example 102 | 525 | 400 | 0.5 | 0.84 | 1.82 | 1.59 | 2.7 |
| Example 103 | 525 | 400 | 0.5 | 0.58 | 4.84 | 1.66 | 1.0 |
| Example 104 | 525 | 400 | 0.5 | 0.75 | 2.05 | 1.65 | 1.4 |
| Example 105 | 525 | 400 | 0.5 | 0.89 | 1.57 | 1.60 | 3.5 |
| Example 106 | 525 | 400 | 0.5 | 0.68 | 3.61 | 1.68 | 2.9 |
| Example 107 | 525 | 400 | 0.5 | 0.73 | 2.64 | 1.59 | 1.6 |
| Example 108 | 525 | 400 | 0.5 | 0.62 | 3.24 | 1.72 | 2.1 |
| Example 109 | 525 | 400 | 0.5 | 0.56 | 4.77 | 1.60 | 3.2 |
| Example 110 | 525 | 400 | 0.5 | 0.60 | 4.64 | 1.59 | 5.2 |
| Example 111 | 525 | 400 | 0.5 | 0.78 | 2.49 | 1.56 | 4.5 |
| Example 112 | 525 | 400 | 0.5 | 0.69 | 3.58 | 1.71 | 3.1 |
| Example 113 | 525 | 400 | 0.5 | 0.52 | 5.00 | 1.59 | 3.3 |
| Example 114 | 525 | 400 | 0.5 | 0.63 | 3.55 | 1.54 | 2.5 |
| Example 115 | 525 | 400 | 0.5 | 0.76 | 2.88 | 1.52 | 2.7 |
| Example 116 | 525 | 400 | 0.5 | 0.72 | 2.71 | 1.68 | 3.0 |
| Example 117 | 525 | 400 | 0.5 | 0.80 | 2.15 | 1.58 | 4.0 |
| Example 118 | 525 | 400 | 0.5 | 0.70 | 3.00 | 1.67 | 3.1 |
| Example 119 | 525 | 400 | 0.5 | 0.70 | 2.88 | 1.72 | 4.6 |
| Example 120 | 525 | 400 | 0.5 | 0.75 | 2.36 | 1.58 | 4.6 |
| Example 121 | 525 | 400 | 0.5 | 0.69 | 2.75 | 1.64 | 2.8 |
| Example 122 | 525 | 400 | 0.5 | 0.69 | 3.41 | 1.67 | 2.2 |
| Example 123 | 500 | 400 | 0.5 | 0.83 | 2.55 | 1.51 | 3.1 |
| Comparative | 525 | — | — | 1.01 | 1.22 | 1.66 | 13.0 |
| example 124 | | | | | | | |
| Comparative | 525 | — | — | 0.98 | 1.09 | 1.65 | 13.3 |
| example 125 | | | | | | | |

TABLE 6B

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (β = 0, d = 0) | | | | | | | | | | | |
| | Fe | | Co | | | | Xₓ = X1ₓ₁X2ₓ₂X3ₓ₃ | | | | | |
| | (1 − (α + β)) × | | α × | | M | | (x = x1 + x2 + x3) | | | | | |
| | (1 − (m + x + d)) | 1 − (α + β) | (1 − (m + X + d)) | α | M | m | X1 | x1 | X2 | x2 | X3 | x3 |
| Example 124 | 0.525 | 0.700 | 0.225 | 0.300 | — | 0.000 | B | 0.250 | — | 0.000 | — | 0.000 |
| Example 125 | 0.553 | 0.700 | 0.237 | 0.300 | — | 0.000 | B | 0.210 | — | 0.000 | — | 0.000 |
| Example 126 | 0.680 | 0.800 | 0.170 | 0.200 | — | 0.000 | B | 0.080 | P | 0.070 | — | 0.000 |
| Example 127 | 0.688 | 0.800 | 0.172 | 0.200 | — | 0.000 | B | 0.110 | P | 0.030 | — | 0.000 |
| Example 128 | 0.672 | 0.800 | 0.168 | 0.200 | — | 0.000 | B | 0.150 | P | 0.010 | — | 0.000 |
| Example 129 | 0.680 | 0.800 | 0.170 | 0.200 | — | 0.000 | B | 0.080 | Si | 0.070 | — | 0.000 |
| Example 130 | 0.680 | 0.800 | 0.170 | 0.200 | — | 0.000 | B | 0.120 | Si | 0.030 | — | 0.000 |
| Example 131 | 0.668 | 0.800 | 0.167 | 0.200 | — | 0.000 | B | 0.160 | Si | 0.005 | — | 0.000 |
| Example 132 | 0.648 | 0.800 | 0.162 | 0.200 | — | 0.000 | B | 0.150 | C | 0.040 | — | 0.000 |
| Example 133 | 0.672 | 0.800 | 0.168 | 0.200 | — | 0.000 | B | 0.140 | C | 0.020 | — | 0.000 |
| Example 134 | 0.668 | 0.800 | 0.167 | 0.200 | — | 0.000 | B | 0.160 | C | 0.005 | — | 0.000 |
| Example 135 | 0.670 | 0.800 | 0.168 | 0.200 | — | 0.000 | B | 0.160 | C | 0.002 | — | 0.000 |
| Example 136 | 0.644 | 0.800 | 0.161 | 0.200 | — | 0.000 | B | 0.120 | P | 0.070 | C | 0.005 |
| Example 137 | 0.756 | 0.900 | 0.084 | 0.100 | — | 0.000 | B | 0.110 | P | 0.030 | C | 0.020 |
| Example 138 | 0.783 | 0.900 | 0.087 | 0.100 | — | 0.000 | B | 0.080 | P | 0.010 | C | 0.040 |
| Example 139 | 0.725 | 0.900 | 0.081 | 0.100 | — | 0.000 | B | 0.120 | P | 0.070 | Si | 0.005 |
| Example 140 | 0.756 | 0.900 | 0.084 | 0.100 | — | 0.000 | B | 0.110 | P | 0.030 | Si | 0.020 |
| Example 141 | 0.783 | 0.900 | 0.087 | 0.100 | — | 0.000 | B | 0.080 | P | 0.010 | Si | 0.040 |
| Comparative | 0.688 | 0.800 | 0.172 | 0.200 | — | 0.000 | B | 0.110 | P | 0.030 | — | 0.000 |
| example 126 | | | | | | | | | | | | |
| Comparative | 0.756 | 0.900 | 0.084 | 0.100 | — | 0.000 | B | 0.110 | P | 0.030 | Si | 0.020 |
| example 127 | | | | | | | | | | | | |
| Comparative | 0.756 | 0.900 | 0.084 | 0.100 | — | 0.000 | B | 0.110 | P | 0.030 | C | 0.020 |
| example 128 | | | | | | | | | | | | |

| | Heat | | | | | | |
|---|---|---|---|---|---|---|---|
| | treatment | Heat press | | | | | |
| | condition | treatment | | | | | |
| | Heat | condition | | | {R(Co1) + | Magnetic | |
| | treatment | Press | Press | | R(Co3)}/ | properties | |
| | Temp. | Temp. | pressure | R(Co4)/ | {R(Fe1) + | Bs | Hc |
| | ° C. | ° C. | MPa | R(Fe4) | R(Fe3)} | (T) | (A/m) |
| Example 124 | 475 | 400 | 0.5 | 0.74 | 2.65 | 1.50 | 3.8 |
| Example 125 | 475 | 400 | 0.5 | 0.54 | 4.39 | 1.72 | 3.3 |
| Example 126 | 475 | 400 | 0.5 | 0.87 | 1.86 | 1.65 | 6.2 |
| Example 127 | 475 | 400 | 0.5 | 0.86 | 1.89 | 1.81 | 6.1 |
| Example 128 | 475 | 400 | 0.5 | 0.57 | 4.10 | 1.70 | 6.7 |
| Example 129 | 475 | 400 | 0.5 | 0.81 | 1.56 | 1.65 | 1.9 |
| Example 130 | 475 | 400 | 0.5 | 0.72 | 3.06 | 1.68 | 3.7 |
| Example 131 | 475 | 400 | 0.5 | 0.51 | 5.32 | 1.72 | 4.0 |
| Example 132 | 475 | 400 | 0.5 | 0.73 | 2.40 | 1.65 | 4.8 |
| Example 133 | 475 | 400 | 0.5 | 0.70 | 2.93 | 1.66 | 3.9 |
| Example 134 | 475 | 400 | 0.5 | 0.64 | 3.10 | 1.65 | 3.3 |
| Example 135 | 475 | 400 | 0.5 | 0.78 | 2.29 | 1.64 | 1.5 |
| Example 136 | 475 | 400 | 0.5 | 0.57 | 5.25 | 1.67 | 3.0 |
| Example 137 | 475 | 400 | 0.5 | 0.54 | 5.46 | 1.75 | 6.6 |
| Example 138 | 475 | 400 | 0.5 | 0.83 | 1.75 | 1.76 | 5.3 |
| Example 139 | 475 | 400 | 0.5 | 0.77 | 2.62 | 1.61 | 3.0 |
| Example 140 | 475 | 400 | 0.5 | 0.80 | 2.89 | 1.73 | 5.0 |
| Example 141 | 475 | 400 | 0.5 | 0.53 | 4.85 | 1.73 | 7.3 |
| Comparative | 475 | — | — | 1.05 | 1.17 | 1.78 | 14.1 |
| example 126 | | | | | | | |
| Comparative | 475 | — | — | 0.95 | 1.32 | 1.71 | 14.9 |
| example 127 | | | | | | | |
| Comparative | 475 | — | — | 0.93 | 1.41 | 1.73 | 12.9 |
| example 128 | | | | | | | |

TABLE 7

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (d = 0) | | | | | | | | | | | |
| | Fe | | Co | | A | | | | | Xₓ = X1ₓ₁X2ₓ₂X3ₓ₃ | | |
| | (1 − (α + β)) × | | α × | | | β × | | M | | (x = x1 + x2 + x3) | | |
| | (1 − (m + x + d)) | 1 − (α + β) | (1 − (m + X + d)) | α | A | (1 − (m + x + d)) | β | M | m | X1 | x1 | X2 |
| Example 142 | 0.581 | 0.696 | 0.251 | 0.300 | Cu | 0.003 | 0.004 | Nb | 0.010 | B | 0.090 | P |
| Example 143 | 0.561 | 0.692 | 0.243 | 0.300 | Cu | 0.006 | 0.008 | Nb | 0.010 | B | 0.110 | P |
| Example 144 | 0.545 | 0.690 | 0.237 | 0.300 | Cu | 0.008 | 0.010 | Nb | 0.010 | B | 0.130 | P |
| Example 145 | 0.579 | 0.685 | 0.254 | 0.300 | Cu | 0.013 | 0.015 | Nb | 0.005 | B | 0.090 | P |
| Example 146 | 0.583 | 0.690 | 0.254 | 0.300 | Cu | 0.008 | 0.010 | Nb | 0.005 | B | 0.110 | P |
| Example 147 | 0.562 | 0.665 | 0.254 | 0.300 | Cu | 0.030 | 0.035 | Nb | 0.005 | B | 0.130 | P |
| Example 148 | 0.776 | 0.970 | 0.016 | 0.020 | Cu | 0.008 | 0.010 | — | 0.000 | B | 0.200 | — |
| Example 149 | 0.641 | 0.796 | 0.161 | 0.200 | Cu | 0.003 | 0.004 | — | 0.000 | B | 0.120 | P |
| Example 150 | 0.749 | 0.892 | 0.084 | 0.100 | Cu | 0.007 | 0.008 | — | 0.000 | B | 0.110 | P |
| Example 151 | 0.774 | 0.890 | 0.087 | 0.100 | Cu | 0.009 | 0.010 | — | 0.000 | B | 0.080 | P |
| Example 152 | 0.712 | 0.885 | 0.081 | 0.100 | Cu | 0.012 | 0.015 | — | 0.000 | B | 0.120 | P |
| Example 153 | 0.749 | 0.892 | 0.084 | 0.100 | Cu | 0.007 | 0.008 | — | 0.000 | B | 0.110 | P |
| Example 154 | 0.776 | 0.892 | 0.087 | 0.100 | Cu | 0.007 | 0.008 | — | 0.000 | B | 0.080 | P |
| Example 155 | 0.551 | 0.680 | 0.243 | 0.300 | Cu | 0.016 | 0.020 | — | 0.000 | B | 0.110 | P |
| Example 156 | 0.551 | 0.680 | 0.243 | 0.300 | Ga | 0.016 | 0.020 | — | 0.000 | B | 0.110 | P |
| Example 157 | 0.551 | 0.680 | 0.243 | 0.300 | Sn | 0.016 | 0.020 | — | 0.000 | B | 0.110 | P |
| Example 158 | 0.551 | 0.680 | 0.243 | 0.300 | La | 0.016 | 0.020 | — | 0.000 | B | 0.110 | P |
| Example 159 | 0.551 | 0.680 | 0.243 | 0.300 | Zn | 0.016 | 0.020 | — | 0.000 | B | 0.110 | P |
| Example 160 | 0.527 | 0.650 | 0.243 | 0.300 | Al | 0.041 | 0.050 | — | 0.000 | B | 0.110 | P |
| Example 161 | 0.551 | 0.680 | 0.243 | 0.300 | Al | 0.016 | 0.020 | — | 0.000 | B | 0.110 | P |
| Example 162 | 0.527 | 0.650 | 0.243 | 0.300 | Mg | 0.041 | 0.050 | — | 0.000 | B | 0.110 | P |
| Example 163 | 0.551 | 0.680 | 0.243 | 0.300 | Mg | 0.016 | 0.020 | — | 0.000 | B | 0.110 | P |
| Example 164 | 0.527 | 0.650 | 0.243 | 0.300 | Ca | 0.041 | 0.050 | — | 0.000 | B | 0.110 | P |
| Example 165 | 0.551 | 0.680 | 0.243 | 0.300 | Ca | 0.016 | 0.020 | — | 0.000 | B | 0.110 | P |
| Example 166 | 0.551 | 0.680 | 0.243 | 0.300 | O | 0.016 | 0.020 | — | 0.000 | B | 0.110 | P |
| Example 167 | 0.551 | 0.680 | 0.243 | 0.300 | S | 0.016 | 0.020 | — | 0.000 | B | 0.110 | P |
| Comparative | 0.545 | 0.690 | 0.237 | 0.300 | Cu | 0.008 | 0.010 | Nb | 0.010 | B | 0.130 | P |
| example 129 | | | | | | | | | | | | |
| Comparative | 0.749 | 0.892 | 0.084 | 0.100 | Cu | 0.007 | 0.008 | — | 0.000 | B | 0.110 | P |
| example 130 | | | | | | | | | | | | |
| Comparative | 0.551 | 0.680 | 0.243 | 0.300 | Ga | 0.016 | 0.020 | — | 0.000 | B | 0.110 | P |
| example 131 | | | | | | | | | | | | |
| Comparative | 0.551 | 0.680 | 0.243 | 0.300 | Sn | 0.016 | 0.020 | — | 0.000 | B | 0.110 | P |
| example 132 | | | | | | | | | | | | |
| Comparative | 0.551 | 0.680 | 0.243 | 0.300 | La | 0.016 | 0.020 | — | 0.000 | B | 0.110 | P |
| example 133 | | | | | | | | | | | | |
| Comparative | 0.551 | 0.680 | 0.243 | 0.300 | Zn | 0.016 | 0.020 | — | 0.000 | B | 0.110 | P |
| example 134 | | | | | | | | | | | | |
| Comparative | 0.527 | 0.650 | 0.243 | 0.300 | Al | 0.041 | 0.050 | — | 0.000 | B | 0.110 | P |
| example 135 | | | | | | | | | | | | |
| Comparative | 0.527 | 0.650 | 0.243 | 0.300 | Mg | 0.041 | 0.050 | — | 0.000 | B | 0.110 | P |
| example 136 | | | | | | | | | | | | |
| Comparative | 0.527 | 0.650 | 0.243 | 0.300 | Ca | 0.041 | 0.050 | — | 0.000 | B | 0.110 | P |
| example 137 | | | | | | | | | | | | |
| Comparative | 0.551 | 0.680 | 0.243 | 0.300 | O | 0.016 | 0.020 | — | 0.000 | B | 0.110 | P |
| example 138 | | | | | | | | | | | | |
| Comparative | 0.551 | 0.680 | 0.243 | 0.300 | S | 0.016 | 0.020 | — | 0.000 | B | 0.110 | P |
| example 139 | | | | | | | | | | | | |

| | | | | Heat | | | | | | |
|---|---|---|---|---|---|---|---|---|---|---|
| | Soft magnetic alloy composition | | | treatmetn | Heat press | | | | | |
| | (Fe_{1-(α+β)}Co_{α}A_{β})_{1-(m+x+d)}MₘXₓD_{d} | | | condition | treatment | | | | | |
| | (d = 0) | | | Heat | condition | | | {R(Co1) + | Magnetic | |
| | Xₓ = X1ₓ₁X2ₓ₂X3ₓ₃ | | | treatment | Press | Press | | R(Co3)}/ | properties | |
| | (x = x1 + x2 + x3) | | | Temp. | Temp. | pressure | R(Co4)/ | {R(Fe1) + | Bs | Hc |
| | x2 | X3 | x3 | ° C. | ° C. | MPa | R(Fe4) | R(Fe3)} | (T) | (A/m) |
| Example 142 | 0.060 | C | 0.005 | 525 | 400 | 0.5 | 0.89 | 1.87 | 1.73 | 4.5 |
| Example 143 | 0.040 | C | 0.030 | 525 | 400 | 0.5 | 0.59 | 3.82 | 1.61 | 5.1 |
| Example 144 | 0.020 | C | 0.050 | 525 | 400 | 0.5 | 0.52 | 4.96 | 1.60 | 2.0 |
| Example 145 | 0.060 | — | 0.000 | 525 | 400 | 0.5 | 0.62 | 3.20 | 1.71 | 3.6 |
| Example 146 | 0.040 | — | 0.000 | 525 | 400 | 0.5 | 0.56 | 5.05 | 1.69 | 4.8 |
| Example 147 | 0.020 | — | 0.000 | 525 | 400 | 0.5 | 0.82 | 1.74 | 1.67 | 4.8 |
| Example 148 | 0.000 | — | 0.000 | 475 | 400 | 0.5 | 0.84 | 2.08 | 1.57 | 2.6 |
| Example 149 | 0.070 | C | 0.005 | 475 | 400 | 0.5 | 0.66 | 3.71 | 1.62 | 5.1 |
| Example 150 | 0.030 | C | 0.020 | 475 | 400 | 0.5 | 0.60 | 3.94 | 1.67 | 2.7 |
| Example 151 | 0.010 | C | 0.040 | 475 | 400 | 0.5 | 0.78 | 2.32 | 1.83 | 3.7 |
| Example 152 | 0.070 | Si | 0.005 | 475 | 400 | 0.5 | 0.56 | 4.58 | 1.71 | 6.3 |
| Example 153 | 0.030 | Si | 0.020 | 475 | 400 | 0.5 | 0.88 | 2.00 | 1.65 | 7.2 |
| Example 154 | 0.010 | Si | 0.040 | 475 | 400 | 0.5 | 0.57 | 4.60 | 1.79 | 4.6 |
| Example 155 | 0.050 | Si | 0.030 | 475 | 400 | 0.5 | 0.72 | 2.73 | 1.58 | 4.3 |
| Example 156 | 0.050 | Si | 0.030 | 475 | 400 | 0.5 | 0.80 | 2.60 | 1.61 | 2.2 |
| Example 157 | 0.050 | Si | 0.030 | 475 | 400 | 0.5 | 0.84 | 1.66 | 1.59 | 6.2 |
| Example 158 | 0.050 | Si | 0.030 | 475 | 400 | 0.5 | 0.76 | 1.66 | 1.65 | 5.3 |
| Example 159 | 0.050 | Si | 0.030 | 475 | 400 | 0.5 | 0.88 | 1.61 | 1.66 | 4.1 |
| Example 160 | 0.050 | Si | 0.030 | 475 | 400 | 0.5 | 0.77 | 1.55 | 1.62 | 6.6 |
| Example 161 | 0.050 | Si | 0.030 | 475 | 400 | 0.5 | 0.78 | 2.09 | 1.60 | 2.9 |
| Example 162 | 0.050 | Si | 0.030 | 475 | 400 | 0.5 | 0.75 | 1.99 | 1.55 | 5.9 |
| Example 163 | 0.050 | Si | 0.030 | 475 | 400 | 0.5 | 0.57 | 4.94 | 1.68 | 6.3 |
| Example 164 | 0.050 | Si | 0.030 | 475 | 400 | 0.5 | 0.80 | 2.81 | 1.52 | 2.9 |
| Example 165 | 0.050 | Si | 0.030 | 475 | 400 | 0.5 | 0.87 | 1.57 | 1.65 | 8.3 |
| Example 166 | 0.050 | Si | 0.030 | 475 | 400 | 0.5 | 0.69 | 3.87 | 1.63 | 2.9 |
| Example 167 | 0.050 | Si | 0.030 | 475 | 400 | 0.5 | 0.60 | 3.22 | 1.58 | 4.4 |
| Comparative | 0.020 | C | 0.050 | 525 | — | — | 0.94 | 1.46 | 1.58 | 13.1 |
| example 129 | | | | | | | | | | |
| Comparative | 0.030 | C | 0.020 | 475 | — | — | 0.98 | 1.27 | 1.65 | 14.1 |
| example 130 | | | | | | | | | | |
| Comparative | 0.050 | Si | 0.030 | 475 | — | — | 1.01 | 1.33 | 1.59 | 13.9 |
| example 131 | | | | | | | | | | |
| Comparative | 0.050 | Si | 0.030 | 475 | — | — | 0.99 | 1.22 | 1.57 | 15.0 |
| example 132 | | | | | | | | | | |
| Comparative | 0.050 | Si | 0.030 | 475 | — | — | 1.05 | 1.32 | 1.64 | 14.3 |
| example 133 | | | | | | | | | | |
| Comparative | 0.050 | Si | 0.030 | 475 | — | — | 1.03 | 1.33 | 1.64 | 13.1 |
| example 134 | | | | | | | | | | |
| Comparative | 0.050 | Si | 0.030 | 475 | — | — | 1.03 | 1.41 | 1.61 | 12.9 |
| example 135 | | | | | | | | | | |
| Comparative | 0.050 | Si | 0.030 | 475 | — | — | 0.96 | 1.33 | 1.53 | 14.4 |
| example 136 | | | | | | | | | | |
| Comparative | 0.050 | Si | 0.030 | 475 | — | — | 0.99 | 1.47 | 1.51 | 13.7 |
| example 137 | | | | | | | | | | |
| Comparative | 0.050 | Si | 0.030 | 475 | — | — | 1.05 | 1.08 | 1.61 | 13.9 |
| example 138 | | | | | | | | | | |
| Comparative | 0.050 | Si | 0.030 | 475 | — | — | 1.01 | 1.44 | 1.57 | 12.9 |
| example 139 | | | | | | | | | | |

TABLE 8

| | Soft magnetic alloy composition | | | | | | | | | | | | | |
|---|---|---|---|---|---|---|---|---|---|---|---|---|---|---|
| | (Fe_{1-(α+β)}Co_{α}A_{β})_{1-(m+x+d)}MₘXₓD_{d} (β = 0, m = 0) | | | | | | | | | | | | | |
| | Fe | | Co | | Xₓ = X1ₓ₁X2ₓ₂X3ₓ₃ | | | | | | D_{d} = D1_{d1} + D2_{d2} | | | |
| | (1 − (α + β)) × | | α × | | (x = x1 + x2 + x3) | | | | | | (d = d1 + d2) | | | |
| | (1 − (m + x + d)) | 1 − (α + β) | (1 − (m + X + d)) | α | X1 | x1 | X2 | x2 | X3 | x3 | D1 | d1 | D2 | d2 |
| Example 168 | 0.567 | 0.700 | 0.243 | 0.300 | B | 0.110 | P | 0.050 | Si | 0.030 | — | 0.000 | — | 0.000 |
| Example 169 | 0.567 | 0.700 | 0.243 | 0.300 | B | 0.110 | P | 0.040 | Si | 0.030 | Ni | 0.010 | — | 0.000 |
| Example 170 | 0.567 | 0.700 | 0.243 | 0.300 | B | 0.110 | P | 0.020 | Si | 0.030 | Ni | 0.030 | — | 0.000 |
| Example 171 | 0.567 | 0.700 | 0.243 | 0.300 | B | 0.110 | P | 0.000 | Si | 0.030 | Ni | 0.050 | — | 0.000 |
| Example 172 | 0.571 | 0.700 | 0.245 | 0.300 | B | 0.110 | P | 0.040 | Si | 0.030 | Mn | 0.005 | — | 0.000 |
| Example 173 | 0.567 | 0.700 | 0.243 | 0.300 | B | 0.110 | P | 0.020 | Si | 0.030 | Mn | 0.030 | — | 0.000 |
| Example 174 | 0.567 | 0.700 | 0.243 | 0.300 | B | 0.110 | P | 0.000 | Si | 0.030 | Mn | 0.050 | — | 0.000 |
| Example 175 | 0.567 | 0.700 | 0.243 | 0.300 | B | 0.110 | P | 0.020 | Si | 0.030 | Ni | 0.015 | Mn | 0.015 |
| Comparative | 0.567 | 0.700 | 0.243 | 0.300 | B | 0.110 | P | 0.040 | Si | 0.030 | Ni | 0.010 | — | 0.000 |
| example 140 | | | | | | | | | | | | | | |
| Comparative | 0.567 | 0.700 | 0.243 | 0.300 | B | 0.110 | P | 0.020 | Si | 0.030 | Mn | 0.030 | — | 0.000 |
| example 141 | | | | | | | | | | | | | | |
| Comparative | 0.567 | 0.700 | 0.243 | 0.300 | B | 0.110 | P | 0.020 | Si | 0.030 | Ni | 0.015 | Mn | 0.015 |
| example 142 | | | | | | | | | | | | | | |

| | Heat | | | | | | |
|---|---|---|---|---|---|---|---|
| | treatment | Heat press | | | | | |
| | condition | treatment | | | | | |
| | Heat | condition | | | {R(Co1) + | Magnetic | |
| | treatment | Press | Press | | R(Co3)}/ | properties | |
| | Temp. | Temp. | pressure | R(Co4)/ | {R(Fe1) + | Bs | Hc |
| | ° C. | ° C. | MPa | R(Fe4) | R(Fe3)} | (T) | (A/m) |
| Example 168 | 475 | 400 | 0.5 | 0.80 | 2.14 | 1.64 | 4.1 |
| Example 169 | 475 | 400 | 0.5 | 0.63 | 2.95 | 1.61 | 4.3 |
| Example 170 | 475 | 400 | 0.5 | 0.72 | 2.35 | 1.71 | 1.7 |
| Example 171 | 475 | 400 | 0.5 | 0.83 | 2.08 | 1.67 | 5.8 |
| Example 172 | 475 | 400 | 0.5 | 0.52 | 4.95 | 1.62 | 4.1 |
| Example 173 | 475 | 400 | 0.5 | 0.60 | 5.22 | 1.65 | 3.2 |
| Example 174 | 475 | 400 | 0.5 | 0.70 | 3.61 | 1.69 | 3.3 |
| Example 175 | 475 | 400 | 0.5 | 0.89 | 2.06 | 1.61 | 5.8 |
| Comparative | 475 | — | — | 0.96 | 1.40 | 1.60 | 13.0 |
| example 140 | | | | | | | |
| Comparative | 475 | — | — | 1.02 | 1.09 | 1.64 | 14.1 |
| example 141 | | | | | | | |
| Comparative | 475 | — | — | 1.00 | 1.17 | 1.59 | 13.3 |
| example 142 | | | | | | | |

TABLE 9

| | Soft magnetic alloy composition | | | | | | | | | | | | |
|---|---|---|---|---|---|---|---|---|---|---|---|---|---|
| | (Fe_{1-(α+β)}Co_{α}A_{β})_{1-(m+x+d)}MₘXₓD_{d} (β = 0) | | | | | | | | | | | | |
| | Fe | | Co | | Mₘ = M1ₘ₁M2ₘ₂M3ₘ₃ | | | | | | Xₓ = X1ₓ₁X2ₓ₂X3ₓ₃ | | |
| | (1 − (α + β)) × | | α × | | (m = m1 + m2 + m3) | | | | | | (x = x1 + x2 + x3) | | |
| | (1 − (m + x + d)) | 1 − (α + β) | (1 − (m + X + d)) | α | M1 | m1 | M2 | m2 | M3 | m3 | X1 | x1 | X2 |
| Example 176 | 0.567 | 0.700 | 0.243 | 0.300 | Nb | 0.018 | Cr | 0.002 | — | 0.000 | B | 0.110 | P |
| Example 177 | 0.567 | 0.700 | 0.243 | 0.300 | Nb | 0.010 | Cr | 0.010 | — | 0.000 | B | 0.110 | P |
| Example 178 | 0.567 | 0.700 | 0.243 | 0.300 | Nb | 0.002 | Cr | 0.018 | — | 0.000 | B | 0.110 | P |
| Example 179 | 0.567 | 0.700 | 0.243 | 0.300 | Nb | 0.009 | Zr | 0.009 | Cr | 0.002 | B | 0.110 | P |
| Example 180 | 0.567 | 0.700 | 0.243 | 0.300 | Nb | 0.009 | Hf | 0.009 | Cr | 0.002 | B | 0.110 | P |
| Example 181 | 0.567 | 0.700 | 0.243 | 0.300 | Zr | 0.009 | Hf | 0.009 | Cr | 0.002 | B | 0.110 | P |
| Example 182 | 0.581 | 0.700 | 0.249 | 0.300 | Zr | 0.120 | — | 0.000 | — | 0.000 | — | 0.000 | — |
| Comparative | 0.567 | 0.700 | 0.243 | 0.300 | Nb | 0.010 | Cr | 0.010 | — | 0.000 | B | 0.110 | P |
| example 143 | | | | | | | | | | | | | |
| Comparative | 0.567 | 0.700 | 0.243 | 0.300 | Nb | 0.009 | Zr | 0.009 | Cr | 0.002 | B | 0.110 | P |
| example 144 | | | | | | | | | | | | | |

| | | | | | | Heat | | | | | | |
|---|---|---|---|---|---|---|---|---|---|---|---|---|
| | Soft magnetic alloy composition | | | | | treatment | Heat press | | | | | |
| | (Fe_{1-(α+β)}Co_{α}A_{β})_{1-(m+x+d)}MₘXₓD_{d} | | | | | condition | treatment | | | | | |
| | (β = 0) | | | | | Heat | condition | | | {R(Co1) + | Magnetic | |
| | Xₓ = X1ₓ₁X2ₓ₂X3ₓ₃ | | | | | treatment | Press | Pres | | R(Co3)}/ | properties | |
| | (x = x1 + x2 + x3) | | | D | | condition | Temp. | pressure | R(Co4)/ | {R(Fe1) + | Bs | Hc |
| | x2 | X3 | x3 | D | d | ° C. | ° C. | MPa | R(Fe4) | R(Fe3)} | (T) | (A/m) |
| Example 176 | 0.030 | Si | 0.030 | — | 0.000 | 525 | 400 | 0.5 | 0.53 | 4.45 | 1.63 | 4.5 |
| Example 177 | 0.030 | Si | 0.030 | — | 0.000 | 525 | 400 | 0.5 | 0.79 | 2.82 | 1.67 | 3.6 |
| Example 178 | 0.030 | Si | 0.030 | — | 0.000 | 525 | 400 | 0.5 | 0.86 | 1.88 | 1.72 | 6.5 |
| Example 179 | 0.030 | Si | 0.030 | — | 0.000 | 525 | 400 | 0.5 | 0.66 | 3.26 | 1.71 | 5.0 |
| Example 180 | 0.030 | Si | 0.030 | — | 0.000 | 525 | 400 | 0.5 | 0.74 | 3.15 | 1.69 | 4.1 |
| Example 181 | 0.030 | Si | 0.030 | — | 0.000 | 525 | 400 | 0.5 | 0.70 | 3.01 | 1.73 | 4.8 |
| Example 182 | 0.000 | — | 0.000 | Ni | 0.050 | 575 | 400 | 0.5 | 0.89 | 1.53 | 1.75 | 9.2 |
| Comparative | 0.030 | Si | 0.030 | — | 0.000 | 525 | — | — | 0.96 | 1.32 | 1.66 | 12.8 |
| example 143 | | | | | | | | | | | | |
| Comparative | 0.030 | Si | 0.030 | — | 0.000 | 525 | — | — | 1.03 | 1.41 | 1.68 | 13.4 |
| example 144 | | | | | | | | | | | | |

Examples 1 to 4 of Table 1 were examples in which the press temperatures were varied. The higher the press temperature was, the lower R(Co4)/R(Fe4) and the higher {R(Co1)+R(Co3)}/{R(Fe1)+R(Fe3)}. Also, Bs increased and Hc decreased.

Examples 5 and 6 of Table 1 were examples in which the press pressures were changed from that of Example 3. The higher the press pressure was, the lower R(Co4)/R(Fe4) and the higher {R(Co1)+R(Co3)}/{R(Fe1)+R(Fe3)}. Also, Bs increased and Hc decreased.

Comparative examples 1 to 5 of Table 1 were experiment examples that the heat press treatment was not necessarily performed after the heat treatment. For all of Comparative examples 1 to 5, R(Co4)/R(Fe4) was too high and {R(Co1)+R(Co3)}/{R(Fe1)+R(Fe3)} was too low. Also, Hc increased. Furthermore, compared to other examples with the same compositions, Bs was lower.

Examples 7 to 9, 8a, and 8b of Table 2 were performed under the same condition as Example 3 except that the ratio between Fe and Co and/or the heat press condition were changed from Example 3. For all of Examples 7 to 9, 8a, and 8b, R(Co4)/R(Fe4) was 0.90 or less, {R(Co1)+R(Co3)}/{R(Fe1)+R(Fe3)} was 1.53 or more. Also, Bs and Hc were good.

Example 7a of Table 2 was an example in which the heat treatment temperature was changed from that of Example 7. R(Co4)/R(Fe4) was 0.90 or less, however, {R(Co1)+R(Co3)}/{R(Fe1)+R(Fe3)} decreased. As a result, Example 7a exhibited increased He compared to Example 7.

Examples 10 to 75, 14a to 14e, and 101 to 182 of Tables 3 to 9 were examples in which the compositions were changed from the examples of Tables 1 and 2, and along with that other conditions were changed if needed. For all of Examples 10 to 75, 14a to 14e, and 101 to 182, R(Co4)/R(Fe4) was 0.90 or less and {R(Co1)+R(Co3)}/{R(Fe1)+R(Fe3)} was 1.53 or more. Further, Bs and Hc were good.

Comparative examples 6 to 8 of Table 3 were carried out under the same conditions as in Examples 10 to 12 except that the heat press treatment was not carried out in Comparative examples 6 to 8. For all of Comparative examples 6 to 8, R(Co4)/R(Fe4) was too high and {R(Co1)+R(Co3)}/{R(Fe1)+R(Fe3)} was too low. Further, He increased. Also, Bs was lower compared to the examples carried out under the same conditions other than the heat press treatment.

Comparative examples 101 to 144 of Tables 2 to 9 were carried out under the same conditions as part of the examples of Tables 2 to 9 except that the heat press treatment was not carried out in any of Comparative examples 101 to 144. For all of Comparative examples 101 to 144, R(Co4)/R(Fe4) was too high and {R(Co1)+R(Co3)}/{R(Fe1)+R(Fe3)} was too low. Further, Hc increased. Also, Bs was lower compared to the examples carried out under the same conditions other than the heat press treatment.

### Experiment Example 2

Various raw material metals were weighed to obtain mother alloys satisfying compositions shown in Tables 10 to 12. Then, inside of a chamber was vacuumed, and the raw material metals were melted using high frequency heating and the mother alloys were produced.

Next, the produced mother alloy was heated and melted to produce molten metal of 1500° C., then a gas atomization method was used to produce a powder. A gas heating temperature was 30° C., and the condition inside the chamber was made close to the vacuumed condition. The obtained powder was classified so that the average particle size was 25 m or so.

Next, the heat treatment was carried out to each powder. The heat treatment temperature was 525° C., and the heat treatment time was one hour for each sample shown in Table 10. For Tables 11 and 12, the heat treatment conditions are shown accordingly. During the heat treatment, the condition inside the chamber was made close to the vacuumed condition.

Next, the heat press treatment was carried out to heat treated powder using a mold for powder molding. The press temperature and the press pressure are shown in Tables 10 and 12. The press time was 10 minutes, and the atmosphere inside the chamber during the heat press treatment was in the air. Note that, for the samples without the information of the heat press treatment, the heat press treatment was not carried out.

Regarding each of the obtained samples, an observation area of 10 nm×10 nm×200 nm was observed using 3DAP. The observation field was divided into 2500 cubic grids of 2 nm×2 nm×2 nm. Then, the content ratio of each element in each grid was measured. The composition obtained by taking the average of content ratio of each element in all of the grids was confirmed to match the composition shown in each table.

Then, R(Co4)/R(Fe4) and {R(Co1)+R(Co3)}/{R(Fe1)+R(Fe3)} were calculated. Results are shown in Tables 10 to 12.

For each sample, Bs and Hc were measured. Specifically, Bs was measured at a magnetic field of 1000 kA/m using a Vibrating Sample Magnetometer (VSM). Also, He was measured using a Hc meter. Results are shown in Tables 10 to 12. When Bs was 1.40 T or more, it was considered good. Further, Hc or less than 7.0 Oe was considered good, and less than 3.0 Oe was considered particularly good.

TABLE 10

| | Soft magnetic alloy composition | | | | | | | | | | |
|---|---|---|---|---|---|---|---|---|---|---|---|
| | (Fe_{1-(α+β)}Co_{α}A_{β})_{1-(m+x+d)}MₘXₓD_{d} | | | | | | | | | | |
| | Fe | | Co | | A | | | | | Xₓ = X1ₓ₁X2ₓ₂ | |
| | (1 − (α + β)) × | | α × | | | β × | | M | | (x = x1 + x2) | |
| | (1 − (m + x + d)) | 1 − (α + β) | (1 − (m + X + d)) | α | A | (1 − (m + x + d)) | β | M | m | X1 | x1 |
| Example 76 | 0.540 | 0.650 | 0.291 | 0.350 | — | 0.000 | 0.000 | Nb | 0.075 | B | 0.060 |
| Comparative | 0.540 | 0.650 | 0.291 | 0.350 | — | 0.000 | 0.000 | Nb | 0.075 | B | 0.060 |
| example 9 | | | | | | | | | | | |
| Example 76 | 0.540 | 0.650 | 0.291 | 0.350 | — | 0.000 | 0.000 | Nb | 0.075 | B | 0.060 |
| Example 77 | 0.536 | 0.638 | 0.294 | 0.350 | — | 0.000 | 0.000 | Nb | 0.075 | B | 0.050 |
| Example 78 | 0.598 | 0.787 | 0.152 | 0.200 | Cu | 0.010 | 0.013 | Nb | 0.030 | B | 0.080 |
| Comparative | 0.598 | 0.787 | 0.152 | 0.200 | Cu | 0.010 | 0.013 | Nb | 0.030 | B | 0.080 |
| example 10 | | | | | | | | | | | |
| Comparative | 0.536 | 0.638 | 0.294 | 0.350 | — | 0.000 | 0.000 | Nb | 0.075 | B | 0.050 |
| example 145 | | | | | | | | | | | |

| | | | | | Heat press | | | | | |
|---|---|---|---|---|---|---|---|---|---|---|
| | Soft magnetic alloy composition | | | | treatment | | | | | |
| | (Fe_{1-(α+β)}Co_{α}A_{β})_{1-(m+x+d)}MₘXₓD_{d} | | | | condition | | | {R(Co1) + | Magnetic | |
| | Xₓ = X1ₓ₁X2ₓ₂ | | | | Press | Press | | R(Co3)}/ | properties | |
| | (x = x1 + x2) | | D | | Temp. | pressure | R(Co4)/ | {R(Fe1) + | Bs | Hc |
| | X2 | x2 | D | d | ° C. | MPa | R(Fe4) | R(Fe3)} | (T) | (Oe) |
| Example 76 | P | 0.035 | — | 0.000 | 400 | 0.5 | 0.84 | 2.01 | 1.63 | 1.9 |
| Comparative | P | 0.035 | — | 0.000 | — | — | 1.02 | 1.04 | 1.60 | 13.4 |
| example 9 | | | | | | | | | | |
| Example 76 | P | 0.035 | — | 0.000 | 400 | 0.5 | 0.84 | 2.01 | 1.63 | 1.9 |
| Example 77 | P | 0.035 | Ni | 0.010 | 400 | 0.5 | 0.79 | 2.81 | 1.71 | 0.9 |
| Example 78 | Si | 0.130 | — | 0.000 | 400 | 0.5 | 0.84 | 2.39 | 1.42 | 1.3 |
| Comparative | Si | 0.130 | — | 0.000 | — | — | 1.00 | 1.05 | 1.39 | 15.1 |
| example 10 | | | | | | | | | | |
| Comparative | P | 0.035 | Ni | 0.010 | — | — | 0.98 | 1.21 | 1.67 | 9.1 |
| example 145 | | | | | | | | | | |

TABLE 11

| | Soft magnetic alloy composition | | | | | | | | | | | | | |
|---|---|---|---|---|---|---|---|---|---|---|---|---|---|---|
| | (Fe_{1-(α+β)}Co_{α}A_{β})_{1-(m+x+d)}MₘXₓD_{d}(β = 0) | | | | | | | | | | | | | |
| | Fe | | Co | | M = M1ₘ₁M2ₘ₂ | | | | Xₓ = X1ₓ₁X2ₓ₂X3ₓ₃ | | | | | |
| | (1 − (α + β)) × | | α × | | (m = m1 + m2) | | | | (x = x1 + x2 + x3) | | | | | |
| | (1 − (m + x + d)) | 1 − (α + β) | (1 − (m + X + d)) | α | M1 | m1 | M2 | m2 | X1 | x1 | X2 | x2 | X3 | x3 |
| Example 183 | 0.553 | 0.700 | 0.237 | 0.300 | Nb | 0.080 | — | — | B | 0.070 | P | 0.050 | Si | 0.010 |
| Example 184 | 0.553 | 0.700 | 0.237 | 0.300 | Nb | 0.040 | — | — | B | 0.090 | P | 0.050 | Si | 0.030 |
| Example 185 | 0.680 | 0.850 | 0.120 | 0.150 | Nb | 0.020 | — | — | B | 0.130 | P | 0.040 | Si | 0.010 |
| Example 186 | 0.567 | 0.700 | 0.243 | 0.300 | Nb | 0.018 | Cr | 0.002 | B | 0.110 | P | 0.030 | Si | 0.030 |
| Example 187 | 0.676 | 0.800 | 0.169 | 0.200 | — | — | — | — | B | 0.130 | P | 0.020 | Si | 0.005 |
| Example 188 | 0.664 | 0.800 | 0.166 | 0.200 | — | — | — | — | B | 0.090 | P | 0.040 | Si | 0.040 |
| Example 189 | 0.592 | 0.700 | 0.254 | 0.300 | — | — | — | — | B | 0.130 | P | 0.020 | C | 0.005 |
| Example 190 | 0.581 | 0.700 | 0.249 | 0.300 | — | — | — | — | B | 0.090 | P | 0.040 | C | 0.040 |
| Example 191 | 0.567 | 0.700 | 0.243 | 0.300 | — | — | — | — | B | 0.110 | P | 0.000 | Si | 0.030 |
| Example 192 | 0.567 | 0.700 | 0.243 | 0.300 | — | — | — | — | B | 0.110 | P | 0.020 | Si | 0.030 |
| Comparative | 0.553 | 0.700 | 0.237 | 0.300 | Nb | 0.080 | — | — | B | 0.070 | P | 0.050 | Si | 0.010 |
| example 146 | | | | | | | | | | | | | | |
| Comparative | 0.680 | 0.850 | 0.120 | 0.150 | Nb | 0.020 | — | — | B | 0.130 | P | 0.040 | Si | 0.010 |
| example 147 | | | | | | | | | | | | | | |
| Comparative | 0.567 | 0.700 | 0.243 | 0.300 | Nb | 0.018 | Cr | 0.002 | B | 0.110 | P | 0.030 | Si | 0.030 |
| example 148 | | | | | | | | | | | | | | |
| Comparative | 0.581 | 0.700 | 0.249 | 0.300 | — | — | — | — | B | 0.090 | P | 0.040 | C | 0.040 |
| example 149 | | | | | | | | | | | | | | |
| Comparative | 0.664 | 0.800 | 0.166 | 0.200 | — | — | — | — | B | 0.090 | P | 0.040 | Si | 0.040 |
| example 150 | | | | | | | | | | | | | | |
| Comparative | 0.567 | 0.700 | 0.243 | 0.300 | — | — | — | — | B | 0.110 | P | 0.020 | Si | 0.030 |
| example 151 | | | | | | | | | | | | | | |

| | | | | | Heat | | | | | | |
|---|---|---|---|---|---|---|---|---|---|---|---|
| | | | | | treatment | Heat press | | | | | |
| | Soft magnetic alloy composition | | | | condition | treatment | | | | | |
| | (Fe_{1-(α+β)}Co_{α}A_{β})_{1-(m+x+d)}MₘXₓD_{d}(β = 0) | | | | Heat | condition | | | {R(Co1) + | Magnetic | |
| | D_{d} = D1_{d1} + D2_{d2} | | | | treatment | Press | Press | | R(Co3)}/ | properties | |
| | (d = d1 + d2) | | | | Temp. | Temp. | pressure | R(Co4)/ | {R(Fe1) + | Bs | Hc |
| | D1 | d1 | D2 | d2 | ° C. | ° C. | MPa | R(Fe4) | R(Fe3)} | (T) | (Oe) |
| Example 183 | — | 0.000 | — | 0.000 | 525 | 400 | 0.5 | 0.80 | 2.00 | 1.48 | 1.9 |
| Example 184 | — | 0.000 | — | 0.000 | 525 | 400 | 0.5 | 0.63 | 2.97 | 1.57 | 3.3 |
| Example 185 | — | 0.000 | — | 0.000 | 525 | 400 | 0.5 | 0.84 | 2.21 | 1.51 | 1.3 |
| Example 186 | — | 0.000 | — | 0.000 | 525 | 400 | 0.5 | 0.69 | 2.09 | 1.56 | 2.0 |
| Example 187 | — | 0.000 | — | 0.000 | 475 | 400 | 0.5 | 0.84 | 1.90 | 1.61 | 2.2 |
| Example 188 | — | 0.000 | — | 0.000 | 475 | 400 | 0.5 | 0.81 | 2.22 | 1.66 | 1.5 |
| Example 189 | — | 0.000 | — | 0.000 | 475 | 400 | 0.5 | 0.76 | 2.48 | 1.67 | 1.8 |
| Example 190 | — | 0.000 | — | 0.000 | 475 | 400 | 0.5 | 0.79 | 2.55 | 1.52 | 1.2 |
| Example 191 | Mn | 0.050 | — | 0.000 | 475 | 400 | 0.5 | 0.69 | 2.61 | 1.60 | 2.5 |
| Example 192 | Ni | 0.015 | Mn | 0.015 | 475 | 400 | 0.5 | 0.84 | 1.69 | 1.49 | 1.1 |
| Comparative | — | 0.000 | — | 0.000 | 525 | — | — | 0.99 | 1.44 | 1.46 | 9.8 |
| example 146 | | | | | | | | | | | |
| Comparative | — | 0.000 | — | 0.000 | 525 | — | — | 1.04 | 1.49 | 1.49 | 8.8 |
| example 147 | | | | | | | | | | | |
| Comparative | — | 0.000 | — | 0.000 | 525 | — | — | 0.98 | 1.24 | 1.55 | 10.1 |
| example 148 | | | | | | | | | | | |
| Comparative | — | 0.000 | — | 0.000 | 475 | — | — | 1.01 | 1.32 | 1.50 | 7.1 |
| example 149 | | | | | | | | | | | |
| Comparative | — | 0.000 | — | 0.000 | 475 | — | — | 1.00 | 1.22 | 1.65 | 8.8 |
| example 150 | | | | | | | | | | | |
| Comparative | Ni | 0.015 | Mn | 0.015 | 475 | — | — | 0.97 | 1.11 | 1.46 | 8.2 |
| example 151 | | | | | | | | | | | |

TABLE 12

| | Soft magnetic alloy composition | | | | | | | | | | | |
|---|---|---|---|---|---|---|---|---|---|---|---|---|
| | (Fe_{1-(α+β)}Co_{α}A_{β})_{1-(m+x+d)}MₘXₓD_{d} (d = 0) | | | | | | | | | | | |
| | Fe | | Co | | A | | | | | Xₓ = X1ₓ₁X2ₓ₂X3ₓ₃ | | |
| | (1 − (α + β)) × | | α × | | | β × | | M | | (x = x1 + x2 + x3) | | |
| | (1 − (m + x + d)) | 1 − (α + β) | (1 − (m + X + d)) | α | A | (1 − (m + x + d)) | β | M | m | X1 | x1 | X2 |
| Example 193 | 0.690 | 0.850 | 0.122 | 0.150 | Cu | 0.008 | 0.010 | Nb | 0.020 | B | 0.110 | P |
| Example 194 | 0.664 | 0.800 | 0.166 | 0.200 | Cu | 0.010 | 0.012 | — | — | B | 0.130 | P |
| Example 195 | 0.656 | 0.800 | 0.164 | 0.200 | Cu | 0.010 | 0.012 | — | — | B | 0.090 | P |
| Comparative | 0.690 | 0.850 | 0.122 | 0.150 | Cu | 0.008 | 0.010 | Nb | 0.020 | B | 0.110 | P |
| example 152 | | | | | | | | | | | | |
| Comparative | 0.656 | 0.800 | 0.164 | 0.200 | Cu | 0.010 | 0.012 | — | — | B | 0.090 | P |
| example 153 | | | | | | | | | | | | |

| | | | | Heat | | | | | | |
|---|---|---|---|---|---|---|---|---|---|---|
| | Soft magnetic alloy composition | | | treatment | Heat press | | | | | |
| | (Fe_{1-(α+β)}Co_{α}A_{β})_{1-(m+x+d)}MₘXₓD_{d} | | | condition | treatment | | | | | |
| | (d = 0) | | | Heat | condition | | | {R(Co1) + | Magnetic | |
| | Xₓ = X1ₓ₁X2ₓ₂X3ₓ₃ | | | treatment | Press | Press | | R(Co3)}/ | properties | |
| | (x = x1 + x2 + x3) | | | Temp. | Temp. | pressure | R(Co4)/ | {R(Fe1) + | Bs | Hc |
| | x2 | X3 | x3 | ° C. | ° C. | MPa | R(Fe4) | R(Fe3)} | (T) | (Oe) |
| Example 193 | 0.040 | Si | 0.010 | 525 | 400 | 0.5 | 0.60 | 3.55 | 1.55 | 4.2 |
| Example 194 | 0.020 | Si | 0.010 | 475 | 400 | 0.5 | 0.67 | 2.22 | 1.59 | 2.0 |
| Example 195 | 0.040 | C | 0.040 | 475 | 400 | 0.5 | 0.76 | 2.09 | 1.57 | 1.1 |
| Comparative | 0.040 | Si | 0.010 | 525 | — | — | 0.96 | 1.09 | 1.52 | 7.1 |
| example 152 | | | | | | | | | | |
| Comparative | 0.040 | C | 0.040 | 475 | — | — | 0.99 | 1.31 | 1.55 | 9.1 |
| example 153 | | | | | | | | | | |

Examples in which the heat press treatments were carried out exhibited R(Co4)/R(Fe4) of 0.90 or less and {R(Co1)+R(Co3)}/{R(Fe1)+R(Fe3)} of 1.53 or more. Further, Bs and Hc were good. Regarding Comparative examples 9 and 10 which were carried out under the same conditions as Examples 76 and 78 except that the heat press treatment was not carried out in Comparative examples 9 and 10, R(Co4)/R(Fe4) was too high and {R(Co1)+R(Co3)}/{R(Fe1)+R(Fe3)} was too low. Further, Hc of Comparative example 9 was too high and Bs of Comparative example 10 was too low. Also, Bs of Comparative example 9 was lower compared to that of Example 76, and Hc of Comparative example 10 was higher compared to that of Example 78.

Also, Example 78 which was a powder form and Example 11 which is a ribbon form were produced under substantially the same conditions other than the shapes of the soft magnetic alloys. Example 78 and Comparative example 10 were produced under substantially the same conditions except that the heat press treatment was carried out in Example 78 but not in Comparative example 10. Example 11 and Comparative example 7 were produced under substantially the same conditions except that the heat press treatment was carried out in Example 11 but not in Comparative example 7. The effects having the heat press treatment were exhibited even when the soft magnetic alloy was a ribbon form and a powder form as long as the compositions of the soft magnetic alloy and the conditions for producing the soft magnetic alloy were substantially the same.

Comparative examples 145 to 153 of Table 10 to 12 were carried out under the conditions same as some of the examples of Tables 10 to 12 except that the heat press treatment was not carried out in Comparative examples 145 to 153. For Comparative examples 145 to 153, R(Co4)/R(Fe4) was too high and {R(Co1)+R(Co3)}/{R(Fe1)+R(Fe3)} was too low. Also, Hc increased. Further, Bs decreased in Comparative examples 145 to 153 compared to the examples carried out under the same conditions other than the heat press treatment.

### REFERENCE SIGNS LISTS

1 . . . Nozzle
2 . . . Molten metal
3 . . . Roll
4 . . . Ribbon
5 . . . Chamber
11 . . . Soft magnetic alloy
13 . . . Press plate

1. A soft magnetic alloy, comprising:
Fe, Co, and one or more selected from the group consisting of M and X; wherein
M is one or more selected from the group consisting of Ti, V, Cr, Zr, Nb, Mo, Hf, Ta, and W;
X is one or more selected from the group consisting of Si, B, C, and P; and
R(Co4)/R(Fe4)≤0.90 is satisfied, provided that
a content ratio of Fe based on a number of atoms in the soft magnetic alloy is Ave(Fe), a content ratio of Co based on a number of atoms in the soft magnetic alloy is Ave(Co), and a total content ratio of M and X based on a number of atoms in the soft magnetic alloy is Ave(M+X),
a volume ratio of a part where a content ratio of Fe is Ave(Fe) or larger and a total content ratio of M and X is less than Ave(M+X) is R(Fe4), and
a volume ratio of a part where a content ratio of Co is Ave(Co) or larger and a total content ratio of M and X is less than Ave (M+X) is R(Co4).

2. A soft magnetic alloy, comprising:
Fe, Co, and one or more selected from the group consisting of M and X, wherein;
M is one or more selected from the group consisting of Ti, V, Cr, Zr, Nb, Mo, Hf, Ta, and W;
X is one or more selected from the group consisting of Si, B, C, and P; and
{R(Co1)+R(Co3)}/{R(Fe1)+R(Fe3)}≥1.53 is satisfied, provided that
a content ratio of Fe based on a number of atoms in the soft magnetic alloy is Ave(Fe), a content ratio of Co based on a number of atoms in the soft magnetic alloy is Ave(Co), and a total content ratio of M and X based on a number of atoms in the soft magnetic alloy is Ave(M+X),
a volume ratio of a part where a content ratio of Fe is Ave(Fe) or larger and a total content ratio of M and X is Ave(M+X) or larger is R(Fe1),
a volume ratio of a part where a content ratio of Fe is less than Ave(Fe) and a total content ratio of M and X is less than Ave(M+X) is R(Fe3),
a volume ratio of a part where a content ratio of Co is Ave(Co) or larger and a total content ratio of M and X is Ave(M+X) or larger is R(Co1), and
a volume ratio of a part where a content ratio of Co is less than Ave(Co) and a total content ratio of M and X is less than Ave(M+X) is R(Co3).

3. The soft magnetic alloy according to claim 1 which is in a ribbon form.

4. The soft magnetic alloy according to claim 1 which is in a powder form.

5. A magnetic component comprising the soft magnetic alloy according to claim 1.

6. The soft magnetic alloy according to claim 2 which is in a ribbon form.

7. The soft magnetic alloy according to claim 2 which is in a powder form.

8. A magnetic component comprising the soft magnetic alloy according to claim 2.
